(19) United States
(12) Patent Application Publication
(10) Pub. No.: US 2026/0291887 A1
(43) Pub. Date: Sep. 24, 2026

(54) SYSTEM

(71) Applicant: SoftBank Group Corp., Tokyo (JP)

(72) Inventor: Masanori SUGITA, Tokyo (JP)

(73) Assignee: SoftBank Group Corp., Tokyo (JP)

(21) Appl. No.: 19/567,081

(22) Filed: Mar. 14, 2026

(30) Foreign Application Priority Data
Mar. 19, 2025 (JP) 2025-045018

(51) Int. Cl. H04L 51/02; G06N 3/0475

(52) U.S. Cl. CPC H04L 51/02; G06N 3/0475

(57) ABSTRACT

A system includes a processor that is configured to acquire attribute information of a user, generate a prompt for instructing generation of an artificial intelligence that mimics a personality based on the acquired attribute information, input the prompt into a generative AI model, and generate the artificial intelligence, and present options to support decision-making of a user by using the generated artificial intelligence and perform evaluation of the options.

### CROSS-REFERENCE TO RELATED APPLICATION

This application is based on and claims priority under 35 USC 119 from Japanese Patent Application No. 2025-045018 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional decision support systems and dialogue systems using artificial intelligence typically rely on static rules or generic models that do not sufficiently reflect an individual user's personality, preferences, or way of thinking. As a result, the options and evaluations presented to the user are often perceived as impersonal or misaligned with the user's actual decision-making style, which reduces the usefulness and reliability of such systems in supporting real-life choices. In addition, in care environments, including elderly care, existing dialogue systems often fail to provide conversations that feel natural, individualized, and emotionally attuned to the user, because they do not actively adapt to the user's personal attributes and real-time utterances. There is therefore a need for a system capable of generating an artificial intelligence that mimics a user's personality based on attribute information of the user, and that can use the generated artificial intelligence both to support user decision-making and to function as a conversation partner in care environments.

### SUMMARY

In order to solve the above-described problems, a system according to one aspect of the present invention comprises a processor, wherein the processor is configured to acquire attribute information of a user, generate a prompt for instructing generation of an artificial intelligence that mimics a personality based on the acquired attribute information, input the prompt into a generative AI model, and generate the artificial intelligence. The processor is further configured to present options to support decision-making of a user by using the generated artificial intelligence and perform evaluation of the options. In one embodiment, the processor is configured to cause the generated artificial intelligence to dynamically adjust evaluation criteria for the options in order to support selection by the user, thereby providing decision support that is personalized to the user's personality and preferences. In another embodiment, the processor is configured to cause the generated artificial intelligence to analyze, in real time, utterance content of the user in a care environment and generate an appropriate response so as to function as a conversation partner in the care environment. Through these means, the system enables generation and utilization of an artificial intelligence that closely reflects the user's personality, thereby improving the relevance and acceptance of decision support and enhancing the quality of interactive communication in care settings.

The term “processor” refers to one or more hardware computing elements, such as a central processing unit (CPU), graphics processing unit (GPU), microcontroller, or a combination thereof, that execute instructions to perform the functions described in the present specification and claims, and may also include associated memory and control circuitry as needed to realize such functions.

The term “attribute information of a user” refers to information that characterizes a user, including but not limited to age, gender, hobbies, areas of expertise, preferences, behavioral tendencies, and personality traits, which is used as a basis for generating an artificial intelligence that mimics the user's personality.

The term “prompt” refers to information expressed in natural language, structured language, or another machine-readable format that is provided as an instruction or condition to a generative AI model in order to control or specify the characteristics, behavior, or output of the artificial intelligence generated by the model.

The term “generative AI model” refers to a machine learning model, such as a large language model, multimodal model, or other generative model, that generates text, voice, images, or other content in response to an input prompt, and that is capable of generating an artificial intelligence configured to mimic a user's personality based on attribute information of the user.

The term “artificial intelligence that mimics a personality” refers to a software-based agent or model generated by a generative AI model, which is configured to produce outputs, such as advice or dialogue, in a manner that reflects or imitates a user's personality, preferences, way of speaking, and decision-making tendencies derived from the user's attribute information.

The term “options” refers to a plurality of selectable candidates, proposals, or courses of action that are presented to a user for comparison or selection in the context of decision-making support, and which may include, for example, different plans, recommendations, responses, or actions.

The term “evaluation of the options” refers to a process in which the system, by using the generated artificial intelligence, provides assessments, scores, rankings, explanations, or comparative analyses of the options, based on one or more evaluation criteria that may reflect the user's personality, preferences, or objectives.

The term “evaluation criteria for the options” refers to one or more rules, weights, thresholds, or factors used to judge or compare the options, including but not limited to criteria relating to risk, cost, benefit, convenience, emotional comfort, or alignment with the user's values and preferences.

The term “dynamically adjust evaluation criteria” refers to changing, updating, or recalibrating, during operation and in response to context or user-related information, one or more of the evaluation criteria for the options, such that the criteria adapt to the user's personality, past selections, current state, or situational conditions.

The term “care environment” refers to an environment in which a user receives care or support, including but not limited to nursing homes, assisted living facilities, hospitals, home care settings, or rehabilitation centers, where emotional support, communication, and monitoring of the user are important.

The term “utterance content of the user” refers to information expressed by the user in the form of speech, text, or other communicative input, including statements, questions, emotional expressions, and responses, which is received by the system and analyzed by the generated artificial intelligence.

The term “real time” refers to processing that is performed with sufficiently low delay such that the user can perceive the response of the system as immediate or substantially immediate in the context of an interactive dialogue, typically within a time frame suitable for natural conversation.

The term “appropriate response” refers to an output generated by the artificial intelligence that is contextually relevant, coherent, and aligned with the user's utterance content, emotional state, and needs, and that is suitable for the given situation, such as providing empathy, clarification, or guidance in a care environment.

The term “conversation partner” refers to a functional role of the generated artificial intelligence in which the artificial intelligence engages in interactive dialogue with the user, by receiving utterances from the user, generating responsive messages, and maintaining continuity and rapport in the conversation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

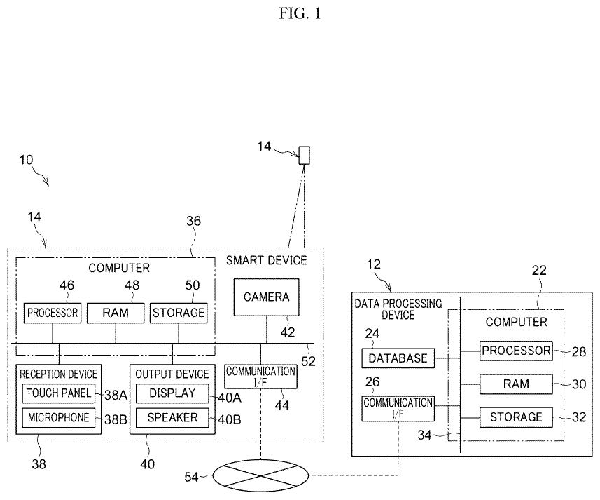

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

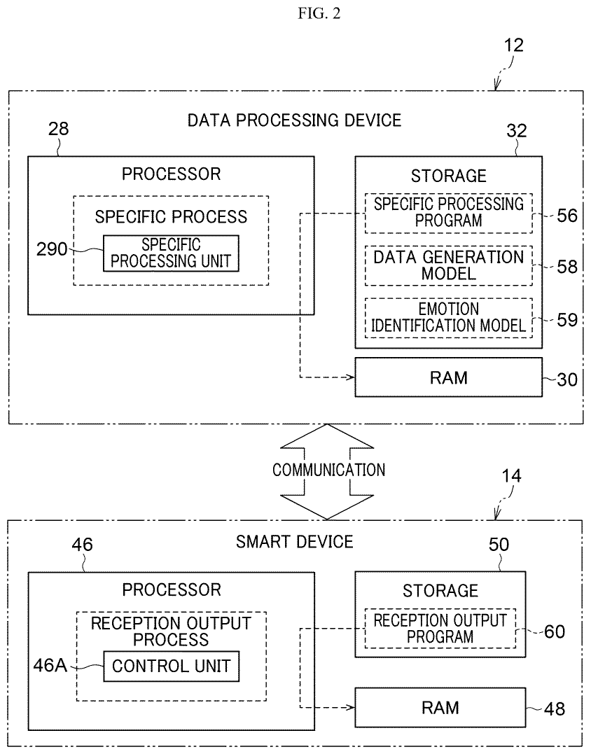

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented dialogue systems and decision support systems typically rely on fixed rule sets or generic models that respond to user inputs without deeply incorporating user-specific attributes or long-term interaction patterns. As a result, these systems exhibit several technical deficiencies.

First, such systems often treat user information as static configuration data and do not convert user attributes, such as age, biological sex, interests, and knowledge level, into structured data that is systematically reused in prompt construction and context management. This leads to inefficient use of storage and processing resources, because each interaction is processed with limited personalization and without optimized context tailoring.

Second, conventional architectures frequently invoke generative models using ad hoc or manually crafted prompts that do not adapt over time based on evaluation of prior user selections. The absence of a feedback loop between user decisions and subsequent prompt sentences results in suboptimal generation of options and explanations, increased token usage, and redundant computation on the generative model side. This degrades response relevance and increases computational load for both the server and the model execution environment.

Third, in multi-turn conversational settings, especially in caregiving environments, many systems fail to maintain a coherent, machine-managed dialogue context that integrates persona information, dialogue history, and external environment information. Without a structured dialogue context and dynamic control of weighting and output parameters, the system cannot efficiently schedule which pieces of information should be emphasized to the generative model, causing unstable response quality and unnecessary bandwidth and processing consumption.

Fourth, existing systems generally do not provide a mechanism in which evaluation information regarding user selections is persistently accumulated and used to update artificial intelligence setting data, including personality setting information and decision-support style parameters. As a consequence, the system cannot improve its internal models of user preference and cannot optimize future option generation or decision-support behavior at the computational level.

Accordingly, there is a need for a computer-implemented system that improves the way in which user information is acquired, structured, and stored; that programmatically constructs and updates prompt sentences and dialogue context data for a generative AI model; and that dynamically adjusts evaluation criteria, option presentation, and persona-related settings based on accumulated evaluation information and dialogue history. Such a system should improve the technical operation of the server-side processing pipeline, including storage management, context construction, and generative model invocation, thereby enhancing computational efficiency, response relevance, and robustness in providing individualized decision support and continuous dialogue.

The specific processing by the specific processing unit 290 of the data processing device 12 in Example 1 is realized by the following means.

The present invention provides a server comprising a processor and a storage device, the processor being configured to acquire user information including at least an age, a biological sex, an area of interest, and a knowledge level of a user via an input device, convert the acquired user information into structured data, and store the structured data in the storage device; to generate, with reference to the structured data, a prompt sentence for causing a generative AI model to generate personality setting information that defines at least a dialogue characteristic, a recommendation policy, and a dialogue topic, input the prompt sentence into the generative AI model, obtain artificial intelligence setting data including the personality setting information from the generative AI model, and store the artificial intelligence setting data in the storage device; to generate, based on the artificial intelligence setting data, dialogue context data including a dialogue history with the user and a new prompt sentence received from the user, input the dialogue context data into the generative AI model, and cause the generative AI model to generate a response sentence adapted to attributes of the user; to generate, based on contents of the response sentence, a plurality of options and explanation information regarding each of the plurality of options for supporting a decision of the user, output the plurality of options via an output device, and store evaluation information regarding a selection input by the user for at least one of the plurality of options in the storage device; and to update, based on the evaluation information and the dialogue history, at least one of a subsequent prompt sentence and the artificial intelligence setting data, and execute, in a continuous manner, individualized decision support processing and dialogue processing for the user. This enables improvement of computer technology by systematically transforming user attribute data and interaction history into machine-usable structured context for generative model invocation, dynamically adjusting model input parameters and persona settings based on stored evaluation information, and thereby enhancing computational efficiency, personalization accuracy, and stability of multi-turn decision-support and conversational processing on the server.

The term “user information” refers to information associated with a user, including at least an age, a biological sex, an area of interest, and a knowledge level, and optionally including additional attributes that characterize preferences, behaviors, or contextual conditions of the user.

The term “structured data” refers to user information or related data elements that have been converted into a machine-readable representation having a defined format or schema, such as key-value pairs, records, or objects, suitable for storage, retrieval, and processing by a computer system.

The term “storage device” refers to a hardware or virtual component configured to store data in a non-transitory manner, such as a magnetic disk, a solid-state drive, a semiconductor memory, or a managed storage service, and to allow read and write access by a processor.

The term “prompt sentence” refers to a machine-generated or machine-constructed natural-language or semi-structured text string configured to be input to a generative AI model in order to instruct the generative AI model to generate a specific type of output, such as personality setting information, dialogue responses, or option recommendations.

The term “generative AI model” refers to a computational model capable of generating output data, including at least natural-language text, in response to input data, such as a prompt sentence or dialogue context data, by using learned parameters obtained through machine learning or similar training techniques.

The term “personality setting information” refers to data elements that define characteristics of an artificial intelligence persona, including at least a dialogue characteristic, a recommendation policy, and a dialogue topic, and that are used to control the style, content, and behavior of responses generated by the generative AI model.

The term “artificial intelligence setting data” refers to data that includes personality setting information and may further include configuration parameters, constraints, or control instructions used by the system to influence how the generative AI model generates responses or performs decision-support operations.

The term “dialogue characteristic” refers to one or more properties indicating how an artificial intelligence agent should communicate in a conversation, including but not limited to tone, politeness level, verbosity, pacing, and degree of empathy.

The term “recommendation policy” refers to rules, strategies, or parameterized preferences that govern how an artificial intelligence agent proposes options, advice, or guidance to a user, including at least the number of options to present, the manner of explanation, and the level of conservativeness or proactiveness.

The term “dialogue topic” refers to one or more subject areas or themes that an artificial intelligence agent is configured to address or emphasize during conversation, such as hobbies, daily activities, health-related matters, or environmental conditions.

The term “dialogue context data” refers to data that represents the state of an ongoing or past dialogue, including at least a dialogue history between the user and the system and a new prompt sentence, and optionally including persona-related information, environment information, and control parameters for the generative AI model.

The term “dialogue history” refers to a sequence of past interaction records between the user and the system, including user messages, system responses, timestamps, and optionally associated metadata, which is used to maintain continuity and coherence across multiple conversation turns.

The term “response sentence” refers to natural-language text generated by the generative AI model in response to input data, such as dialogue context data, and delivered by the system as an output message to the user.

The term “option” refers to a candidate choice or course of action presented to the user by the system for the purpose of supporting decision making, where a plurality of options may be presented simultaneously for comparison or selection.

The term “explanation information” refers to descriptive text, reasoning, or justification data associated with an option, which explains properties, benefits, risks, or conditions related to the option in order to assist the user in making an informed decision.

The term “evaluation information” refers to data representing the user's reaction to, or selection among, one or more options, including at least a selected option identifier, and optionally including explicit ratings, feedback comments, or inferred preferences derived from user behavior.

The term “weighting parameter” refers to a numerical or symbolic value used by the system to adjust the relative importance of different components within dialogue context data, such as particular user attributes, past messages, or environment information, when forming input to the generative AI model.

The term “output control parameter” refers to a configuration value that influences characteristics of the output generated by the generative AI model, such as output length, level of detail, diversity, or safety constraints.

The term “environment information” refers to data representing external conditions or contextual factors relevant to the user or conversation, such as weather information, time information, location information, or facility-related information, obtained from an external information source.

The term “external information source” refers to an information system, service, or database that is separate from the server of the present invention and that provides environment information or other supplemental data via a communication network.

The term “caregiving environment” refers to a physical or virtual setting in which a user receives care or support for daily living, health, or well-being, such as a residential care facility, a home-care situation, or a similar support context.

The term “continuous dialogue partner” refers to an artificial intelligence function or agent that is configured to engage in ongoing, multi-turn conversation with the user over time, maintaining contextual continuity, and providing responses adapted to the user's state and environment.

The term “individualized decision support processing” refers to processing by which the system generates and presents options and explanations tailored to a specific user's attributes, preferences, and past evaluation information, rather than using a generic or uniform set of options.

The term “continuous dialogue processing” refers to processing that maintains and updates dialogue context across multiple turns of conversation, enabling the system to track and respond to evolving user inputs, states, and preferences over time.

The term “input device” refers to a component or interface through which the user provides data to the system, including at least a graphical user interface, a keyboard, a pointing device, a touch panel, or a voice input device.

The term “output device” refers to a component or interface through which the system presents data to the user, including at least a display, a speaker, a haptic output device, or a combination thereof.

In one or more embodiments, a system includes a server, at least one terminal, and a communication network. The server includes at least one processor, a main memory, and a non-transitory storage device such as a magnetic disk or a solid-state drive. The terminal includes at least one processor, a memory, a display, an input device, and optionally a microphone and a speaker. The communication network includes, for example, a packet-switched network such as the Internet.

The server executes an operating system such as a general-purpose server operating system, and application software including a web server component (for example, software of the type of an HTTP server), an application framework (for example, software of the type of a server-side scripting framework), a database management system (for example, software of the type of a relational database engine), and a generative AI client module configured to communicate with a generative AI model execution environment. The generative AI model execution environment is implemented either as an external service accessible via an API over the network or as a local service running on one or more accelerator devices such as graphics processing units.

The server uses a database schema including at least the following logical tables or collections: a user profile store for structured user information, an AI persona store for artificial intelligence setting data, and a dialogue log store for dialogue history and evaluation information. The user profile store contains records including a user identifier, age, biological sex, area(s) of interest, knowledge level, and optionally additional attributes such as language preference, device type, and caregiver-related information. The server represents hobbies and areas of interest as normalized string identifiers or categorical codes to reduce redundancy and to improve data retrieval efficiency.

The terminal executes a client application such as a web browser or a native mobile application. The terminal provides a graphical user interface including forms and chat-style interfaces. The client application uses hypertext markup and scripted logic or native user interface components to collect user information, display options and responses, and send and receive data through an application programming interface exposed by the server. The terminal converts user input into a structured representation such as a dictionary or key-value set, but transmits it over the network as serialized data using a structured format such as a text-based serialization.

The user operates the terminal to input user information including at least the user's age, biological sex, area of interest, and knowledge level. The user enters this information using input controls such as text fields, selection lists, or check boxes. The terminal displays validation messages when input is incomplete or inconsistent and thereby assists the user in providing correct data.

The server receives the user information from the terminal and converts the user information into structured data. The server normalizes the input by, for example, converting free-text hobbies into standardized labels using a mapping table, converting age strings into numerical values, and mapping knowledge levels into a limited set of predefined categories. The server stores the structured data in the user profile store. By converting heterogeneous user inputs into normalized and indexed fields, the server improves storage efficiency and enables consistent retrieval and reuse of user attributes in later processing stages.

The server generates a prompt sentence for a generative AI model based on the structured data. The server composes the prompt sentence according to a prompt template that includes fixed instruction segments and variable segments filled with normalized user attributes. For example, the server uses a template such as:
“You are configuring a personalized AI companion.
User profile: age [AGE], biological sex [SEX], areas of interest: [INTERESTS], knowledge level: [KNOWLEDGE].
Define a communication style, conversation topics, and a decision-support style suitable for this user, who may sometimes feel lonely and needs gentle, clear guidance.
Output a description of tone, typical conversation topics, and how you will present and explain options.”

The server replaces placeholder tokens [AGE], [SEX], [INTERESTS], and [KNOWLEDGE] with actual values from the structured user data. The server then transmits the prompt sentence to the generative AI model execution environment. When the generative AI model is provided by an external service, the server sends the prompt by way of an API request including the prompt sentence and model parameters such as a temperature parameter, a maximum output length, and one or more safety-related parameters.

The generative AI model is, in one embodiment, a transformer-based neural network having an encoder-decoder or decoder-only architecture. The generative AI model uses multi-head self-attention layers, feed-forward layers, positional encodings, and an embedding layer that maps tokenized text into high-dimensional vectors. The generative AI model is trained on large-scale text datasets using a language modeling objective that minimizes a cross-entropy loss between predicted tokens and actual tokens, and model weights are updated using gradient-based optimization such as stochastic gradient descent with variants including adaptive learning rate algorithms. The generative AI model maintains learned representations for semantic similarity, discourse coherence, and stylistic patterns.

In a training phase performed before deployment, a training server supplies input-output text pairs to the generative AI model. The training server computes gradients of a loss function, updates weight matrices of attention and feed-forward layers, and adjusts regularization and normalization parameters. The training can include domain-specific fine-tuning using conversation logs from care settings, with differential weighting applied to examples containing decision-support explanations, thereby biasing the model toward detailed, cautious guidance.

The server does not rely on the generative AI model to autonomously determine all behavior; instead, the server controls the model by constructing prompt sentences and dialogue context data in a structured and programmatic way. The server uses the structured user profile and previously stored evaluation information as features that are preprocessed outside the model, and, through controlled insertion of these features into the prompt sentence and context sequence, the server shapes model behavior in a manner that reduces the need for heuristic post-processing.

The server receives a generated text output from the generative AI model in response to the persona-generation prompt sentence. The output includes natural-language descriptions of tone, typical topics, and a decision-support style. The server parses the output text, for example by searching for delimiters, key phrases, or predefined labels, and converts the parsed data into artificial intelligence setting data. The artificial intelligence setting data contains structured fields representing tone descriptors (e.g., “gentle,” “patient”), topic categories (e.g., “gardening,” “daily health habits”), and numerical or categorical decision-support style parameters (e.g., number of options to present, preference for conservative recommendations, detail level of explanations).

The server stores the artificial intelligence setting data in the AI persona store associated with the given user. By storing a compact, structured representation rather than raw free text, the server facilitates efficient retrieval and reuse. When the server later constructs dialogue context data, the server can include only relevant parameters, reducing the number of tokens to be processed by the generative AI model and thereby improving computational efficiency and reducing communication load.

The user uses the terminal to start an interactive session with the individualized artificial intelligence. The terminal retrieves persona-related information from the server or from local cache and displays a greeting message consistent with the persona tone. The user inputs a prompt sentence, such as:
“I want to start a new hobby, but I get tired easily. What would you recommend?”

The terminal transmits this prompt sentence and a session identifier to the server. The server retrieves the corresponding artificial intelligence setting data and dialog history from the storage device. The dialogue history includes records of prior user requests, prior system responses, and associated evaluation information derived from user interactions with presented options.

The server generates dialogue context data by combining the following elements: (1) a system-level instruction segment derived from the artificial intelligence setting data, (2) selected portions of the dialogue history, and (3) the new prompt sentence from the user. The system-level instruction segment includes, for example, language such as:
“You are a gentle, patient AI companion for an elderly user.
You should propose 2 or 3 simple options suitable for a user who tires easily.
You should explain each option in clear, short sentences and avoid technical jargon.”

The server selects portions of the dialogue history based on recency, relevance to the current prompt, and constraints on context size. The server computes weighting parameters for past interactions; for example, responses that led to positive evaluation information (such as user selection of recommended options) are marked as high priority, and responses discarded or ignored by the user are marked as low priority. The server uses these weights to decide which past messages to include or truncate when constructing the dialogue context for the generative AI model. This selection procedure is implemented as a deterministic algorithm that ranks past messages by a composite score, thereby enabling the server to control context content in a non-trivial way beyond naive chronological truncation.

The server embeds the system instruction segment, selected past messages, and the new prompt sentence into a sequence of role-tagged text segments, which collectively constitute the dialogue context data. By programmatically controlling the composition and ordering of these segments, the server causes the generative AI model to emphasize relevant prior information, which leads to more coherent and efficient responses.

When the generative AI model generates a response sentence based on the dialogue context data, the server receives the response sentence and, instead of simply forwarding it to the user, the server performs post-processing and option construction. The server analyzes the response sentence to identify explicit or implicit candidate actions or recommendations. The server uses natural-language analysis algorithms such as keyword extraction and simple pattern recognition to locate phrases describing distinct options. The server then generates a plurality of options and explanation information for each option by structuring these extracted phrases into short option labels and note-like explanations.

The server presents the plurality of options to the user through the terminal, for example by enumerating them in a list with selectable controls. The user reviews the options and selects one or more options. The terminal transmits the user's selection to the server. The server records evaluation information corresponding to the selection, including at least the selected option identifier and possibly explicit ratings or comments. The server stores this evaluation information in the dialogue log store.

The server uses the evaluation information to update artificial intelligence setting data and prompt-generation parameters. For example, if the user consistently chooses options related to indoor activities, the server updates a preference vector for the user to increase the weight given to indoor-related topics. The server then modifies subsequent system instruction segments to de-emphasize outdoor activities. This update is performed as a rule-based or statistical adjustment to configuration parameters outside the generative AI model, which represents a technical mechanism distinct from human mental processes or simple automation of existing tasks.

By repeatedly incorporating evaluation information and dialogue history into the personalization process, the server improves the match between generated content and user preferences, thereby reducing the number of iterations required for the user to reach a satisfactory decision. This yields a technical benefit by decreasing the total volume of data transmitted between the server and the generative AI model execution environment, lowering latency, and reducing server-side computational cost per successful decision-support episode.

In a caregiving environment, the user uses the terminal, which may be installed in a care facility or a home-care setting. The user inputs or speaks utterance content such as:
“What is the weather like today? Should I go for a walk?”

The terminal may convert spoken input into text using a speech recognition module and send the text to the server. The server optionally accesses an external information source such as a weather information system via the communication network. The server obtains environment information including temperature, precipitation, and weather conditions. The server composes a dialogue context that includes both the artificial intelligence setting data and a concise summary of the environment information. For example, the server may include a segment such as:
“Current environment: It is sunny, temperature about 25 degrees Celsius, no rain forecast in the next two hours.”

The server supplies the dialogue context data to the generative AI model. The generative AI model generates a response sentence that integrates the environment information with personalized guidance, for example:
“Today it is sunny and around 25 degrees. If you feel well, a short walk outside could be pleasant. Please take water with you and rest if you feel tired.”

The server transmits this response sentence to the terminal, which displays the text or converts it to speech. By incorporating environment information into the context and by controlling the model input through structured data, the server improves the technical relevance and safety of suggestions, and reduces the need for manual cross-referencing of external data by caregivers or users.

The described system improves computer technology in several ways. First, the server implements a non-trivial mechanism for constructing and updating prompt sentences and dialogue context data using structured user information, environment information, and evaluation information. This mechanism reduces redundant and irrelevant tokens passed to the generative AI model, thus reducing processing time and network communication load. Second, the server separates artificial intelligence setting data from raw dialogue text, enabling reuse of a compact persona representation across multiple sessions. This results in more efficient cache utilization and faster initialization of new dialogue sessions.

Third, the server uses a rule-based or algorithmic weighting mechanism for selecting and ordering dialogue history snippets to build context. This mechanism prioritizes high-value historical entries based on measured user evaluations rather than simply adding recent or fixed-length history. This selection improves the accuracy and relevance of the generative AI model's outputs, and reduces the risk of context-window overflow. Fourth, by using evaluation information to update persona and prompt-generation parameters, the server implements a feedback loop that continually refines model control without retraining the base neural network. This design provides adaptability through light-weight configuration changes at the application layer, which is a technical improvement over static prompt engineering.

In additional embodiments, the server may implement different generative AI models, such as models with varying numbers of layers or attention heads, and may store multiple model identifiers in artificial intelligence setting data. The server can select an appropriate model based on factors such as device capability, required response time, or sensitivity of content. For example, the server may use a smaller model for routine chit-chat in a caregiving environment and a larger model for complex decision-support queries. This dynamic model selection reduces average computation cost while maintaining necessary accuracy when needed.

In another embodiment, the server applies data augmentation on stored dialogue logs when performing fine-tuning or adaptation of the generative AI model in a controlled environment. The server can generate paraphrased versions of user utterances or introduce controlled noise into options to increase robustness. During training, the server minimizes a loss function that includes terms for content accuracy, stylistic adherence to artificial intelligence setting data, and alignment with user selection frequencies. By optimizing this multi-term loss function, the system configures the generative AI model to more effectively follow persona constraints encoded by the server and to reduce the number of corrections and overrides required at inference time.

Across these embodiments, the server, the terminal, and the generative AI model execution environment cooperate in a manner that is not limited to abstract information processing. The server uses concrete data structures, storage schemas, and algorithmic control over model input and output to achieve improved computational efficiency, improved personalization accuracy, and reduced communication overhead, thereby providing a technical solution that extends beyond mere automation of human reasoning.

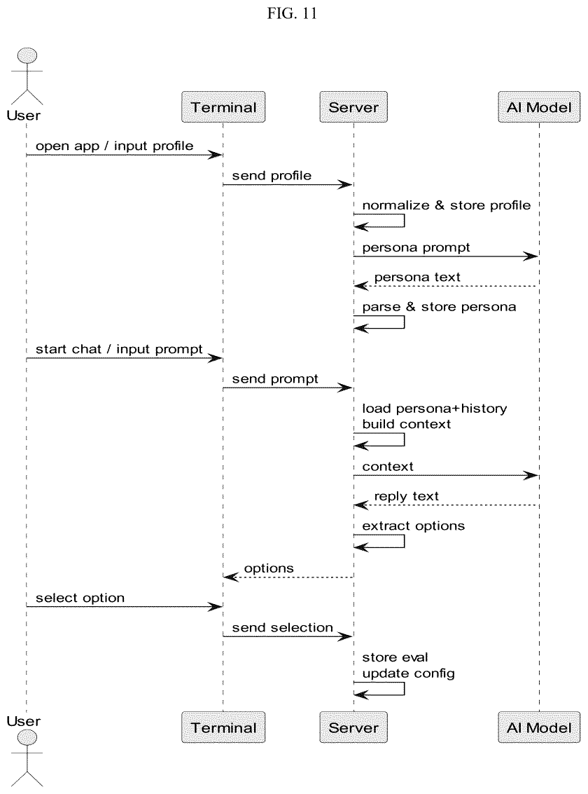

The following describes the processing flow using FIG. 11.

### Step 1:

User operates the terminal to launch an application and start a profile registration screen.
User inputs attribute values including at least age, biological sex, areas of interest, and knowledge level through graphical input controls.
Input: Raw text and selections entered by the user (e.g., “78”, “female”, “gardening, classical music”, “basic health knowledge”).
Output: A set of user attribute fields held in the terminal's memory (e.g., internal key-value pairs).

Terminal validates the format of each field, for example by checking that the age consists of digits within a reasonable range and that the biological sex and knowledge level correspond to predefined categories. The terminal converts the raw input into an internal data structure and flags missing or inconsistent values. If validation fails, the terminal displays error messages and requests correction; if validation succeeds, the terminal prepares the validated attributes for transmission.

### Step 2:

Terminal converts the validated user attributes into a structured message and sends the message to the server.
Input: Validated user attribute fields stored in the terminal memory.
Output: A serialized data packet transmitted to the server via a network connection.

Terminal assembles the attribute values and a user identifier into a structured representation and serializes this representation into a text-based message according to a predefined protocol. The terminal opens a secure communication channel and transmits the serialized message to an application endpoint exposed by the server. The terminal then waits for a response indicating whether the user profile has been accepted and stored.

### Step 3:

Server receives the user attribute message and normalizes it into structured data.
Input: Serialized user attribute message received from the terminal.
Output: Normalized user profile record stored in a user profile store.

Server parses the serialized message to extract individual fields such as age, biological sex, and lists of interests. The server converts age from a string to a numerical type, maps free-text interests to standardized codes using a lookup table, and maps knowledge level descriptions to internal category identifiers. The server then assembles these normalized values into a user profile record and writes the record into a database or other storage device, generating or updating an index for fast retrieval.

### Step 4:

Server constructs a persona-generation prompt sentence for a generative AI model based on the normalized user profile.
Input: Normalized user profile record from the user profile store.
Output: A text prompt sentence specifying persona requirements for the generative AI model.

Server retrieves the profile record using the user identifier and inserts the attribute values into a predefined prompt template. For example, the server creates a prompt such as:
“You are configuring a personalized AI companion.

User profile: age 78, biological sex female, areas of interest: gardening and classical music, knowledge level: basic health knowledge.

Define a communication style, conversation topics, and a decision-support style suitable for this user, who may sometimes feel lonely and needs gentle, clear guidance.

Output a description of tone, typical conversation topics, and how you will present and explain options.”

The server concatenates the static instruction text and the filled-in attribute placeholders to form one coherent prompt sentence, and stores this prompt in memory for immediate use.

### Step 5:

Server sends the persona-generation prompt sentence to the generative AI model and obtains artificial intelligence setting data.
Input: Persona-generation prompt sentence constructed by the server.
Output: Parsed artificial intelligence setting data including persona parameters stored in an AI persona store.

Server packages the prompt sentence and control parameters, such as maximum output length and generation temperature, into a model request. The server then transmits this request to a generative AI model execution environment. The generative AI model processes the prompt by tokenizing the text, applying attention and feed-forward computations through multiple neural network layers, and generating a response that describes tone, topics, and decision-support style. The server receives the response text, detects structural markers or key phrases in the response, and extracts fields such as “tone: gentle and patient,” “conversation topics: gardening, classical music, daily routine,” and “decision-support style: provide 2 and 3 options with simple explanations.” The server converts these extracted fields into artificial intelligence setting data and stores them as a structured persona record associated with the user.

### Step 6:

User initiates an interactive session using the terminal, and the terminal requests persona information from the server.
Input: User action to start a conversation and a user identifier stored on the terminal.
Output: Persona configuration data received from the server and stored locally on the terminal.

Terminal sends a request containing the user identifier to the server, asking for persona-related configuration. The server retrieves the artificial intelligence setting data from the AI persona store and returns the structured persona data, including tone descriptors, preferred topics, and decision-support style parameters. The terminal stores this persona data in local memory and updates the user interface to indicate that a personalized companion is active.

### Step 7:

User inputs a conversational prompt sentence on the terminal to request decision support or dialogue.
Input: Natural-language text entered or spoken by the user (e.g., “I want to start a new hobby, but I get tired easily. What would you recommend?”).
Output: A structured chat request sent from the terminal to the server.

Terminal captures the user's text from an input field or converts speech to text using a local or external speech recognition engine. The terminal combines the prompt sentence with session information and a reference to the persona configuration. The terminal serializes this combined data and sends it to the server through a chat endpoint, then waits for a generated response.

### Step 8:

Server builds dialogue context data by combining system instructions, dialogue history, and the new user prompt sentence.
Input: User prompt sentence and session identifier from the terminal, artificial intelligence setting data from the AI persona store, and dialogue history from the dialogue log store.
Output: Dialogue context data formatted for input to the generative AI model.

Server retrieves the persona record and past dialogue logs for the session. The server composes a system-level instruction segment using persona parameters, for example:
“You are a gentle, patient AI companion for an elderly user. You should propose 2 or 3 simple options suitable for a user who tires easily and explain each option in clear, short sentences.”

The server selects a subset of prior dialogue entries based on recency and relevance, assigning higher selection priority to messages associated with positive user evaluations. The server then orders the system instruction, selected history messages, and the new user prompt into a structured sequence. The server forms dialogue context data by labeling each segment (such as system text, user text, or assistant text) and concatenating the text segments into a single ordered representation ready to be passed to the generative AI model.

### Step 9:

Server calls the generative AI model with the dialogue context data and obtains a response sentence.
Input: Dialogue context data including system instruction, selected history, and the new user prompt.
Output: A generated response sentence tailored to the user attributes and current context.

Server sends the dialogue context data and generation parameters to the generative AI model execution environment. The generative AI model encodes the sequence of tokens, computes attention scores across positions, and propagates these representations through internal layers to predict subsequent tokens. The model produces a response text that addresses the user's prompt while adhering to the style and guidance specified in the system instruction. The server receives the generated response sentence and checks it for length, prohibited content, or formatting irregularities, modifying or truncating the text if necessary according to predefined rules.

### Step 10:

Server analyzes the response sentence to derive a plurality of options and explanation information for decision support.
Input: Generated response sentence from the generative AI model.
Output: A structured set of options with associated explanation texts stored temporarily in server memory.

Server scans the response sentence to identify segments that describe alternative actions or recommendations, using pattern-matching rules and keyword detection. For example, if the response contains phrases such as “You could try bonsai,” “You could grow herbs indoors,” and “You could keep a small journal,” the server extracts these phrases as candidate options. The server assigns each option a label (e.g., “Start bonsai,” “Grow herbs,” “Keep a journal”) and associates a brief explanation derived from the corresponding response text. The server arranges the options in an order corresponding to persona preferences or evaluation-based weighting, and prepares this set for presentation to the user.

### Step 11:

Terminal receives the options and explanation information from the server and presents them to the user.
Input: Structured set of options and explanations sent by the server.
Output: Visual or audio presentation of multiple selectable options on the terminal.

Terminal parses the received data and renders each option as a selectable element in the user interface, displaying the option label and a short explanation. The terminal may number the options, highlight recommended items, or group related options. The user can review the list using the display and, if available, listens to spoken output generated by a text-to-speech component. The terminal waits for the user to perform a selection action on one of the options.

### Step 12:

User selects one or more options and submits evaluation information to the server.
Input: User interaction with option controls on the terminal (e.g., tapping an option, providing a rating, or entering a comment).
Output: Evaluation information related to selected options transmitted to the server.

Terminal detects the user's selection and any additional feedback such as a numeric rating or textual comment. The terminal packages the selected option identifier, feedback values, and session identifier into a structured message and sends this evaluation information to the server. The terminal then waits for confirmation that the evaluation has been recorded.

### Step 13:

Server records the evaluation information and updates configuration parameters for future interactions.
Input: Evaluation information from the terminal and existing dialogue history and persona data from storage.
Output: Updated dialogue log entries and modified artificial intelligence setting data or prompt parameters.

Server writes a new entry into the dialogue log store, associating the selected options and feedback with the corresponding response sentence and user prompt. The server computes updated preference weights for topics or action types based on the evaluation; for example, a consistently chosen indoor activity may receive a higher preference score. The server updates persona configuration fields or internal weighting parameters used in prompt construction. This update alters how future system instructions are generated and how dialogue history is selected, so that subsequent interactions are more closely aligned with observed user preferences.

### Step 14:

Server constructs subsequent prompt sentences and dialogue context data using the updated configuration, thereby refining future decision support and dialogue.
Input: Updated artificial intelligence setting data, updated weighting parameters, and new user prompts received in later interactions.
Output: Refined prompt sentences and dialogue context data that yield more accurate and efficient responses.

Server, upon receiving new conversational prompts from the user, retrieves the updated persona and weighting parameters and generates system instructions that emphasize more preferred topics or safer decision-support patterns. The server applies revised selection rules to choose dialogue history fragments, reducing inclusion of low-value messages and focusing on interactions that led to positive user outcomes. By doing so, the server reduces the size of the context while preserving key information, which decreases computational cost for the generative AI model and improves response quality.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented dialogue systems that utilize a generative AI model generally treat users as anonymous or generic entities and do not tightly integrate structured user attribute information, longitudinal dialogue history, and feedback on decision options into the prompt construction process. As a result, such systems often generate responses that are only superficially personalized and that fail to provide consistent, persona-aligned guidance for user decision-making over time. This limitation is particularly problematic in environments such as care facilities, where users may require continuous, context-aware support and emotionally appropriate interaction tailored to their individual characteristics and states.

Furthermore, existing architectures typically issue independent calls to a generative AI model for each user query, with minimal reuse of accumulated interaction data and without systematic adjustment of option evaluation criteria based on past user selections. The absence of an integrated mechanism for associating user attribute information, dialogue history information, and evaluation information for decision options leads to inefficient use of computational resources and degraded quality of responses, because the generative AI model must repeatedly infer context from scratch. This can result in inconsistent behavior of the dialogue agent, increased token usage, and latency overhead when scaling to many simultaneous users.

In addition, known systems lack a robust server-side control framework that dynamically constructs and refines prompt sentences to enforce persona consistency, context continuity, and adaptive decision support. In such systems, prompt design is often static, ad hoc, or delegated to client-side logic, making it difficult to centrally manage conversational policies, ensure reliable behavior across a population of users, and optimize server performance. This is especially limiting in multi-terminal environments where multiple user devices communicate with a server, and where there is a need to maintain separate, persistent conversational contexts for many users in parallel.

Accordingly, there is a need for a computer-implemented technique that improves the way a generative AI model is orchestrated by a server. The technique should allow the server to acquire and persist user attribute information, construct structured prompt sentences that encode a user-specific persona and evolving context, transmit such prompt sentences and user inputs to the generative AI model, and manage returned responses and option evaluations in an integrated manner. By improving these server-side processes, it is possible to enhance the technical performance of the dialogue system itself, including response relevance, context management, scalability, and resource efficiency, rather than merely automating human decision support logic.

The specific processing by the specific processing unit 290 of the data processing device 12 in Application Example 1 is realized by the following means.

The present invention provides a server comprising a processor and a storage device configured to acquire user attribute information for each user and store the acquired user attribute information as user-specific information sets in the storage device, generate structured prompt sentences that define behavior of dialogue agents imitating personalities of the users on the basis of the stored user attribute information and dialogue history information, input the prompt sentences to a generative AI model to cause the generative AI model to generate personality-imitating artificial intelligences, construct inquiry data including the prompt sentences and input sentences from the users, transmit the inquiry data to the generative AI model, acquire response sentences output from the generative AI model, generate option information for supporting decision-making of the users on the basis of content of the acquired response sentences, output the option information as presentation data to user terminals, acquire selection results from the user terminals and record the selection results as evaluation information in the storage device, and manage, for a plurality of users, the user attribute information, the dialogue history information, and the evaluation information in association with each other in the storage device to individually adjust, for each user, configuration elements of the prompt sentences and content of the option information to be presented. This enables a technically improved orchestration of the generative AI model by the server, in which persona-consistent and context-dependent prompts are automatically synthesized and refined on the basis of persistent user-specific data, thereby enhancing response coherence, reducing redundant computation, and allowing scalable, multi-user, decision-supportive dialogue processing across multiple user terminals.

The term “processor” refers to a hardware computing element, such as a central processing unit or a processing core, that executes instructions of a program to perform logical operations, data processing, and control of other components of the system.

The term “storage device” refers to a hardware component or combination of components, such as a memory or a storage medium, that stores data, programs, and parameters in a non-transitory manner for access by the processor.

The term “user attribute information” refers to structured data representing characteristics of a user, including but not limited to age, gender, preferences, interests, expertise, and other profile-related parameters.

The term “user-specific information set” refers to an aggregation of user attribute information and optionally other data associated with a single user, stored in the storage device in a form that allows retrieval and processing on a per-user basis.

The term “dialogue history information” refers to data representing past exchanges between a user and the system, including prior user inputs, system responses, timestamps, and any derived summaries or annotations.

The term “prompt sentence” refers to a text sequence or structured textual instruction generated by the processor and provided as input to a generative AI model in order to specify a role, behavior, context, or constraints for the model's response generation.

The term “generative AI model” refers to a machine-learned model configured to generate output content, such as natural language text, in response to input data or a prompt sentence, by predicting subsequent tokens or structures based on learned statistical relationships.

The term “personality-imitating artificial intelligence” refers to an instantiated behavioral configuration of the generative AI model that is controlled by a prompt sentence so as to emulate a personality, style, or preferences corresponding to a particular user.

The term “dialogue agent” refers to a logical entity implemented by the generative AI model that engages in interactive exchanges with a user by receiving user inputs and outputting response sentences.

The term “inquiry data” refers to a data structure transmitted from the server to the generative AI model that includes at least a prompt sentence and one or more user input sentences, and may additionally include metadata such as identifiers or context markers.

The term “input sentence” refers to a text string or sequence of tokens that represents content entered or spoken by a user and provided to the system for processing.

The term “response sentence” refers to a text string or sequence of tokens generated by the generative AI model in response to inquiry data, including the prompt sentence and one or more input sentences.

The term “option information” refers to data representing one or more selectable alternatives, suggestions, or courses of action presented to the user for the purpose of supporting decision-making.

The term “presentation data” refers to formatted data derived from option information and response sentences that is suitable for output to a user terminal, such as display text, structured menu data, or audio-ready text.

The term “evaluation information” refers to data representing feedback or results related to the option information, including user selections, acceptance or rejection of options, and any associated scoring, weighting, or annotations.

The term “selection result” refers to data indicating which option or options among presented option information have been chosen or otherwise acted upon by the user.

The term “configuration elements of the prompt sentence” refers to constituent parts or parameters of a prompt sentence, including persona description, instructions, contextual summaries, and formatting structures that can be individually modified by the processor.

The term “preference information” refers to data indicating likes, dislikes, tendencies, or habitual choices of a user, used to tailor the behavior of the dialogue agent and the content of responses and options.

The term “physical and mental state information” refers to data representing conditions of a user's body or mind, such as fatigue level, mood, stress, or health-related status, which can influence the generation of responses and decision-support options.

The term “care environment” refers to a facility or setting in which users receive assistance or support, including but not limited to residential care facilities, medical institutions, or assisted living environments.

The term “user terminal” refers to an electronic device operated directly or indirectly by a user, such as a portable communication device, a tablet, a personal computer, or a dedicated terminal, configured to exchange data with the server and present information to the user.

The term “persona-consistent behavior” refers to behavior of the dialogue agent in which style, tone, and content of the responses remain aligned with the personality, preferences, and characteristics defined for a particular user.

The term “context-dependent response” refers to a response sentence generated by the generative AI model that takes into account prior dialogue history information, current input sentences, and other stored user-specific information.

In one embodiment, a server is implemented as an information processing apparatus comprising at least one processor, a main memory, a non-transitory storage device, and a network interface. The server executes an operating system such as a general-purpose server operating system and runs an application stack including a web server component, an application framework, and a database management component. The server uses a programming language such as a high-level scripting language to implement functional modules for user profile management, prompt sentence generation, interaction with a generative AI model, and conversation state management.

The server uses a relational database system stored on the storage device to maintain persistent data structures. The server defines, for example, a user table for user attribute information, a dialogue_history table for dialogue history information, and an evaluation table for evaluation information. Each table contains fields such as a user identifier, timestamps, and content fields for text data. The server stores user attribute information, including age, gender, hobbies, areas of expertise, preference information, and physical and mental state information, in normalized form so that the processor can efficiently retrieve and combine these fields during prompt sentence construction.

The server uses a generative AI model deployed on a remote computation environment. The generative AI model is implemented as a multi-layer neural network, for example a transformer-based language model, comprising an embedding layer, multiple self-attention layers, feed-forward layers, and a softmax output layer over a vocabulary of tokens. The generative AI model is trained in advance on large text corpora by minimizing a cross-entropy loss function between predicted token distributions and ground-truth tokens. During training, the generative AI model updates weight parameters of the self-attention layers and feed-forward layers using gradient-based optimization such as stochastic gradient descent or Adam. The generative AI model learns token embeddings, positional encodings, and attention parameters that capture statistical relationships between words and phrases.

The server communicates with the generative AI model via an application programming interface exposed over a network. The server formats requests as text sequences that include a prompt sentence and one or more user input sentences. The server transmits these sequences as token strings, and the generative AI model performs forward propagation over the transformer architecture. For each input token position, the generative AI model computes query, key, and value vectors, applies scaled dot-product attention, aggregates contextual information, and passes intermediate activations through non-linear feed-forward layers. The generative AI model outputs a probability distribution over the vocabulary for each subsequent token and generates a response sentence token by token according to the learned probability distributions.

The server constructs the prompt sentence using a dedicated prompt-generation module running on the processor. The server retrieves, from the database, the user attribute information corresponding to a user identifier and a subset of the dialogue history information associated with that user. The server applies string concatenation and template filling operations to embed these values into a fixed instruction pattern. In one example, the server generates the following prompt sentence:
“You are a generative AI model that imitates the following resident's persona. Age: 75,
Gender: female, Hobbies: gardening, reading, Expertise: nursing. Speak gently and encouragingly.
User: I'm not sure what to do this afternoon. Any ideas?Assistant:”

In another example, the server generates the following prompt sentence:
“Create a persona based on the following information: Age: 75, Gender: female, Hobbies: gardening, reading, Expertise: nursing.”

The server defines configuration elements of the prompt sentence, including: (i) a system role description that specifies the generative AI model's role as a persona-consistent dialogue agent; (ii) a persona description that encodes user attribute information; (iii) a context section that summarizes relevant dialogue history information; and (iv) a query section that includes the latest user input. The server stores parameters indicating how many previous dialogue turns to include, how to summarize prior turns, and how to map user attributes to textual descriptions. The server adjusts these parameters per user based on evaluation information so that the prompt sentence is optimized for response relevance and token efficiency.

The server manages evaluation information as structured data indicating which option information the user has selected in the past and how the user has reacted to previous suggestions. The server aggregates evaluation information across sessions and applies statistical analysis, such as frequency counts or weighted scoring, to infer effective presentation strategies. The server uses these statistics to adjust the configuration elements of subsequent prompt sentences, for example, by increasing emphasis on hobbies that the user frequently selects or by reducing mention of suggestions previously rejected. This adaptive adjustment is implemented through non-trivial prompt re-parameterization rules stored in the database and applied by the prompt-generation module.

The server communicates with one or more terminals operated by users in a care environment. Each terminal is implemented, for example, as a tablet device, a portable communication device, or a desktop client. The terminal executes a client application that displays a graphical interface for entering user attribute information and for conducting dialogue. The terminal uses a communication module to send HTTP or similar protocol requests containing attribute information and input sentences to the server and to receive response sentences and option information from the server. The terminal renders the received text in a chat-like interface and may optionally convert the text to audio using a text-to-speech library running locally on the terminal.

The user interacts with the system by operating the terminal. The user initially enters attribute information such as age, gender, hobbies, and expertise through input fields. The user may later provide updates regarding physical and mental state information, such as “I feel tired today” or “I am anxious about my health.” The terminal sends these updates to the server, and the server records them in the database as part of the user-specific information set. The user then types or speaks natural language questions, such as “What should I do this afternoon?” or “Should I stay in my room or go to the lounge to talk with others?” The terminal captures the user input, converts speech to text when necessary, and forwards the resulting input sentence to the server.

The server integrates the user attribute information, dialogue history information, and evaluation information to generate a persona-consistent prompt sentence with constrained structure. By embedding user-specific features and historical interaction patterns into the prompt sentence, the server causes the generative AI model to operate under a non-generic, persona-conditioned context. This configuration enables the generative AI model to produce response sentences that are more contextually coherent and tailored than responses generated from naive, stateless prompts. As a result, the server reduces redundant token content describing context on every call, improving communication efficiency and reducing latency.

The server uses an internal representation of conversation state. The server may maintain a compressed conversation summary for each user, computed by periodically passing a subset of dialogue history through a summarization routine, which can also be implemented via the generative AI model or a separate neural model. The server then stores the summary text as part of the dialogue history information. This design allows the server to provide sufficient context in the prompt sentence without exceeding token limits, thereby improving computational efficiency. The server selects and updates the summary based on heuristics or scoring rules that measure semantic relevance between new user inputs and past dialogue content.

The server defines a specific data flow for each interaction. When the server receives a new input sentence from a terminal, the server identifies the user identifier, retrieves the corresponding user attribute information and relevant dialogue history summary, and then constructs the prompt sentence according to predefined templates. The server then creates inquiry data that combines the prompt sentence and the input sentence. The server sends the inquiry data to the generative AI model and waits for a response sentence. Once the server receives the response sentence, the server parses the text to identify potential option information, such as explicit suggestions or recommended actions. The server may apply pattern recognition rules or a lightweight classifier to segment the response into discrete options.

The server generates structured option information from the segmented content. For example, when the response sentence is “You could spend a little time in the garden, and then sit comfortably and read a book you enjoy,” the server may generate two options: (1) “Spend time in the garden,” and (2) “Sit and read a book.” The server packages these options as presentation data with identifiers and description fields and sends them to the terminal. The terminal presents these options to the user in a selectable list. When the user chooses one of the options, the terminal returns the selection result to the server, and the server records this selection result as evaluation information, including an option identifier, a timestamp, and contextual tags.

The server leverages this structured evaluation information to refine future prompts and to guide the generative AI model to produce more relevant options. For example, if the user frequently selects low-activity suggestions when physical and mental state information indicates fatigue, the server modifies the prompt sentence to emphasize the user's preference for low-exertion activities in similar future contexts. This modification takes the form of additional textual instructions, such as “The resident is feeling slightly tired today. Suggest 2-3 gentle activities that require minimal physical effort.” The server thereby creates a feedback loop where computational structures, rather than manual human tuning, regulate the persona description and decision-support behavior.

The server improves computer technology by introducing a specific, machine-implemented framework for prompt sentence construction, conversation state management, and evaluation-driven adaptation. The server uses specialized data structures and algorithms to encode and retrieve context, reducing the need for repeated, full-context reconstruction on each generative AI model call. This approach improves processing speed because the server performs efficient database queries and reuses structured summaries instead of transmitting large raw histories. It also reduces network bandwidth and token consumption in the communication with the generative AI model.

The server additionally improves response precision and reduces error rates by controlling the generative AI model with more informative, structured prompts grounded in persistent user data. Because the generative AI model receives well-defined persona descriptions and concise, relevant context, the probability distribution over candidate tokens becomes more concentrated around contextually appropriate words, resulting in fewer off-topic or inconsistent responses. The server's control logic, which modifies prompt configuration elements based on evaluation information, provides a non-conventional, algorithmic method for dynamically adjusting the behavior of the generative AI model.

The server can employ alternative generative AI model architectures. In one variation, the generative AI model is a sequence-to-sequence model with an encoder-decoder structure, where the encoder processes the prompt sentence and the decoder generates the response sentence. In another variation, the server uses a multi-task model that jointly predicts both natural language output and structured option information. In these cases, the server still generates the prompt sentence in accordance with user attribute information and dialogue history information, but adjusts token formatting and control tokens to match the model's requirements. The underlying training procedures, such as teacher forcing during decoding and loss functions combining cross-entropy with auxiliary option-prediction losses, are defined so that the model learns to follow the server's structured prompts.

The server may also integrate rule-based components with the generative AI model. For example, the server can apply pre-defined constraint rules that limit certain types of suggestions based on safety requirements or medical constraints specific to the care environment. The server embeds rule-relevant information into the prompt sentence, such as “Avoid recommending strenuous physical activities,” and validates generated options against rule sets before final presentation. This hybrid approach uses the generative AI model's flexibility for language generation while ensuring compliance with technical constraints derived from stored rules.

The terminal can implement user interface variations to accommodate different user capabilities. In one variation, the terminal provides a voice-only interface, where a wake word detection module activates recording, and a local or remote automatic speech recognition component converts audio to text before sending it to the server. In another variation, the terminal displays larger fonts and simplified option lists for users with visual or cognitive limitations. In each case, the underlying server-side processing (prompt generation, generative AI model orchestration, response handling, and evaluation-based adaptation) remains unchanged, demonstrating modularity between front-end interfaces and back-end technical processing.

The user benefits from this system not only in terms of improved dialogue quality but also in terms of the reliability and predictability of the persona-imitating artificial intelligence. Because the server consistently applies the same data structures and algorithms to construct prompts and to manage conversation states, the generated responses exhibit stable style and content patterns for each user. This stability reduces cognitive load for users in care environments and improves usability of the terminals, which in turn increases the amount of interaction data available for further adaptation and prompting improvements.

Through these concrete constructions of hardware components, software modules, data structures, neural network configurations, and algorithmic control flows, the system provides more than a generic automation of human conversational behavior. The server implements a specific technical improvement in the way computing resources, including the generative AI model, are orchestrated to manage multi-user, context-rich, persona-based dialogue at scale.

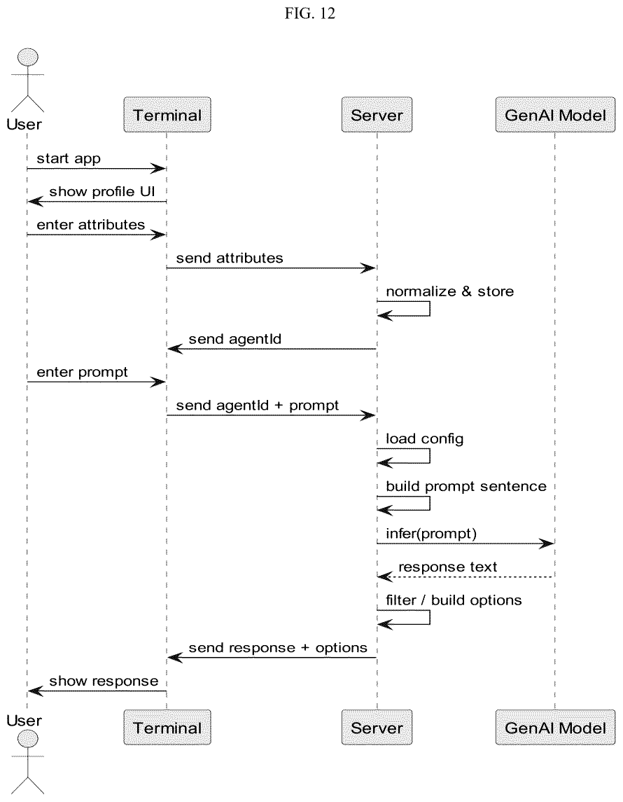

The following describes the processing flow using FIG. 12.

### Step 1:

Server initializes system resources and data structures.
Server loads configuration parameters from the storage device, including database connection settings, prompt sentence templates, and generative AI model endpoint information.
Server establishes a connection to the relational database and prepares tables for user attribute information, dialogue history information, and evaluation information.
Input: configuration files and schema definitions stored on the storage device.
Processing: server parses configuration text, instantiates in-memory objects (such as template structures and connection pools), and verifies connectivity to the generative AI model endpoint.
Output: initialized server state, open database connections, and in-memory prompt configuration ready for subsequent steps.

### Step 2:

Terminal presents an interface for user attribute input.
Terminal loads a user interface from the server or a local application bundle and renders input fields for age, gender, hobbies, expertise, preference information, and physical and mental state information.
User enters attribute values into the displayed fields using touch, keyboard, or voice input.
Input: user actions on the terminal interface (e.g., typed characters, touch events, voice input converted to text).
Processing: terminal captures raw input events, aggregates them into a structured data object representing user attribute information, and performs basic validation (such as checking mandatory fields).
Output: structured user attribute information (e.g., a key value map) stored temporarily in terminal memory.

### Step 3:

Terminal transmits user attribute information to the server.
Terminal serializes the user attribute information into a request message and sends the message to the server over a network connection.
Input: user attribute structure created in Step 2.
Processing: terminal encodes the structure into a textual or binary format (such as JSON or similar), opens a network connection using a communication protocol, and attaches necessary identifiers (session ID, device ID) to the message.
Output: network request containing user attribute information delivered to the server.

### Step 4:

Server stores user attribute information as a user-specific information set.
Server receives the request from the terminal and parses the serialized attribute data into internal variables.
Server creates or updates a record in the user attribute table with a unique user identifier.
Input: serialized user attribute information from the terminal.
Processing: server decodes the message, validates field types and ranges (for example, converting age to an integer, splitting hobbies into a list of tokens), and constructs database insert or update commands.
Output: persistent user-specific information set stored in the database, and a generated user identifier returned to the terminal.

### Step 5:

Terminal stores the user identifier and confirms profile creation.
Terminal receives the user identifier from the server and associates it with the local session.
Terminal displays a confirmation message and prepares the dialogue interface for the user.
Input: response message from the server containing the user identifier.
Processing: terminal extracts the user identifier, saves it in local storage or memory, and switches the interface from profile input view to dialogue view.
Output: active session state on the terminal that includes the user identifier, and a ready-to-use dialogue screen.

### Step 6:

User inputs a natural language message for conversation.
User views the dialogue screen on the terminal and types or speaks a question or statement, such as “I'm not sure what to do this afternoon. Any ideas?”
Input: user's textual or spoken utterance.
Processing: terminal captures the text directly or converts speech to text using a speech recognition function.
Output: a clean text input sentence ready to be sent to the server, associated with the stored user identifier.

### Step 7:

Terminal sends the input sentence and user identifier to the server.
Terminal packages the user identifier and the input sentence into a request and transmits it to the server.
Input: user identifier and input sentence from Step 6.
Processing: terminal populates request fields, performs any needed encoding, and issues a network call to the server's dialogue endpoint.
Output: network request containing user identifier and input sentence delivered to the server.

### Step 8:

Server retrieves user attribute information and dialogue history.
Server receives the request, reads the user identifier, and queries the database for the corresponding user attribute information and recent dialogue history records.
Input: user identifier and input sentence from the terminal.
Processing: server executes database queries to retrieve user attributes, prior user messages, past response sentences, and previous evaluation information. Server may also retrieve or update a stored dialogue summary reflecting prior interactions.
Output: in-memory representation of user attribute information, dialogue history information, and evaluation information associated with the current user.

### Step 9:

Server constructs a context-aware prompt sentence.
Server uses the retrieved data to generate a structured prompt sentence for the generative AI model.
Server inserts values such as age, gender, hobbies, expertise, and current or recent physical and mental state into a template.
Server also includes a concise summary of relevant dialogue history and the latest user input sentence.
Input: user attribute information, dialogue history information, evaluation information, and the current input sentence.
Processing: server applies string concatenation, template substitution, and rule-based adjustments (for example, increasing emphasis on low-effort activities if the evaluation information indicates frequent selection of such activities when the user is tired).
Output: a prompt sentence such as:
“You are a generative AI model that imitates the following resident's persona. Age: 75, Gender: female, Hobbies: gardening, reading, Expertise: nursing. The resident is feeling slightly tired today. Speak gently and encouragingly.
User: I'm not sure what to do this afternoon. Any ideas?
Assistant:”

### Step 10:

Server forms inquiry data for the generative AI model.
Server combines the prompt sentence with the input sentence and any necessary metadata into a single data structure.
Input: constructed prompt sentence from Step 9 and original input sentence from Step 7.
Processing: server tokenizes the text if required, or arranges the prompt sentence and user input in a specified sequence expected by the generative AI model interface.
Output: inquiry data object ready to be sent to the generative AI model endpoint.

### Step 11:

Server sends inquiry data to the generative AI model and receives a response.
Server transmits the inquiry data over the network to the environment hosting the generative AI model and waits for a generated response sentence.
Input: inquiry data created in Step 10.
Processing: server opens or uses an existing network connection, sends the textual content, and the generative AI model executes internal neural network computation (embedding, attention, feed-forward propagation) to produce a sequence of output tokens. Server receives the output as a text response.
Output: response sentence generated by the generative AI model and returned to the server as a text string.

### Step 12:

Server analyzes the response sentence to extract option information.
Server parses the response sentence to identify explicit suggestions or recommendations.
Input: response sentence from Step 11.
Processing: server may apply pattern-matching rules or lightweight natural language parsing to detect segments corresponding to individual options, such as “spend a little time in the garden” and “relax with a book you enjoy.” Server then converts each segment into a structured record containing an option identifier and a description.
Output: structured option information list derived from the response sentence.

### Step 13:

Server generates presentation data for the terminal.
Server prepares a payload that includes the original response sentence and the structured option information.
Input: response sentence from Step 11 and option information from Step 12.
Processing: server wraps these elements into a data object with fields for text display and selection controls. Server may also attach metadata such as timestamps and context tags.
Output: presentation data ready to be transmitted to the terminal.

### Step 14:

Server sends response sentence and option information to the terminal.
Server transmits the prepared presentation data back to the requesting terminal.
Input: presentation data from Step 13.
Processing: server serializes the data and sends it over the established communication channel.
Output: network response containing the response sentence and option information delivered to the terminal.

### Step 15:

Terminal displays the response and options to the user.
Terminal receives the presentation data and renders the response sentence as conversational text and the option information as selectable items (for example, buttons or list entries).
Input: presentation data from the server.
Processing: terminal parses the data, inserts the response sentence into the chat display, and builds user interface elements corresponding to each option.
Output: graphical presentation of the AI-generated response and selectable options on the terminal screen.

### Step 16:

User selects an option or provides feedback.
User reviews the displayed response and options and chooses one option, rejects all options, or provides additional free-text feedback.
Input: displayed response and option list on the terminal.
Processing: user performs a selection action (such as tapping a button) or enters further text.
Output: a selection result or additional input captured by the terminal.

### Step 17:

Terminal sends the selection result or additional input back to the server.
Terminal packages the selected option identifier, user identifier, and any additional comments into a request to the server.
Input: user selection result or new user input from Step 16.
Processing: terminal encodes this data into a message, attaches session identifiers, and transmits it to the server.
Output: network request containing selection result and optional additional input delivered to the server.

### Step 18:

Server records evaluation information and updates internal state.
Server receives the selection result, associates it with the corresponding option information and response sentence, and stores it as evaluation information in the database.
Input: selection result and optionally additional user comments from Step 17.
Processing: server constructs an evaluation record that includes user identifier, option identifier, timestamp, and context markers (such as current physical and mental state). Server executes database insert operations and may update aggregate statistics per user (for example, counters for frequently chosen option types).
Output: updated evaluation information and adjusted aggregate metrics stored in the database.

### Step 19:

Server adjusts prompt configuration for future interactions.
Server uses newly recorded evaluation information to modify configuration elements of future prompt sentences.
Input: evaluation information and aggregate statistics updated in Step 18.
Processing: server applies algorithmic rules, such as increasing weights for successfully selected option categories or adding constraints to avoid repeatedly rejected suggestions.
These rules alter template parameters (for instance, specifying to “suggest low-exertion activities first” when recent selections favor such activities).
Output: updated prompt configuration parameters stored in memory or in a configuration table, which influence subsequent prompt sentence generation in Step 9.

### Step 20:

Server and terminal support continuous, multi-turn dialogue.
Server waits for the next input sentence from the terminal and, upon receipt, repeats Steps 8 to 19 using the accumulated dialogue history information and updated prompt configuration.

Terminal continues to present new responses and options, while the user iteratively interacts with the system.
Input: successive user input sentences and selection results over time.
Processing: server incorporates additional dialogue history, refines summaries, and continually tunes prompt parameters based on evaluation information, thereby generating increasingly tailored prompt sentences and more relevant response sentences.
Output: ongoing, persona-consistent, context-dependent dialogue between the user and the system, with improved technical performance in terms of response relevance, efficiency of context handling, and reduced communication overhead with the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented support systems that utilize artificial intelligence models typically treat all users in a uniform manner, regardless of individual attributes such as age group, activity preference, or domain knowledge level. In many implementations, a generic model prompt is hard-coded on an application server, and a large-scale generative model is queried with only the latest user utterance. As a result, the model output is weakly conditioned on a persistent representation of the user, and the system is often unable to provide decision support or conversational support that is stably aligned with long-term user characteristics.

From the standpoint of computer technology, existing systems exhibit several technical shortcomings. First, user attribute information is often stored as unstructured text and is not normalized into higher-level categories that can be efficiently reused by a generative model. This leads to redundant or inconsistent conditioning data, and forces the server to repeatedly perform expensive prompt construction logic for each interaction, which increases computation load and latency. Second, the absence of an explicit agent configuration layer bound to a user identifier makes it difficult for the server to manage per-user behavior policies, model prompts, and safety constraints in a structured and cacheable form. This results in inefficient memory usage, repeated transmission of large prompt segments, and higher network and processing overhead.

Further, many existing conversational systems do not maintain a clear separation between (i) base configuration information that defines an artificial agent's role, style, and decision policies, and (ii) per-message prompt sentences that encode immediate user queries. Without this separation, the server cannot reliably reconstruct context across sessions, cannot easily adapt prompts to different environments such as caregiving environments, and cannot apply targeted safety and appropriateness filters at the agent level. This degrades the robustness and predictability of system behavior from the perspective of computer system design.

In a caregiving context in particular, conventional systems are not designed to compute and maintain caregiving-specific dialogue policies as first-class configuration data on a server. Instead, any “caregiving tone” is often embedded in ad hoc textual instructions passed with each model invocation. This makes it difficult for the processor to programmatically switch between general-purpose and caregiving-specific behaviors, and prevents efficient reuse of such policies across sessions and across different devices. As a consequence, the system tends to deliver inconsistent support to elderly users, increases the number of model tokens per request, and wastes computational resources on repeated encoding of similar instructions.

Additionally, conventional systems lack mechanisms for systematically generating and storing normalized agent configuration information, including a reusable system-level prompt sentence, associated identifiers, and persistent evaluation criteria for decision options. This limits the ability of the server to dynamically adjust evaluation criteria based on dialogue history and user attributes in a computationally efficient manner, and reduces the effectiveness of using cached configuration data to shorten prompts and reduce token processing load in the generative model.

There is therefore a need for an improved computer-implemented system that, at the server level, acquires user attribute information via a terminal, normalizes the attribute information into higher-level categories, and automatically generates and stores structured agent configuration information including a base prompt sentence. There is also a need for such a system to manage per-user agent identifiers, to compose model input by programmatically combining stored configuration data with newly received natural-language prompt sentences, and to apply safety and appropriateness post-processing in a unified manner. By organizing prompt construction and agent configuration as first-class data and control flows, the system can technically improve how a processor orchestrates a generative AI model, reduce redundant computation, and provide more stable, contextually appropriate responses, especially in resource-constrained or latency-sensitive environments such as caregiving environments.

The specific processing by the specific processing unit 290 of the data processing device 12 in Example 2 is realized by the following means.

The present invention provides a server comprising a processor and a memory storing instructions which, when executed by the processor, cause the processor to control a terminal interface to acquire attribute information of a user from a terminal operated by the user; to store the acquired attribute information in the memory as structured information and to normalize the attribute information into higher-level categories; to generate, on the basis of the normalized attribute information, a base prompt sentence that defines characteristics and usage purposes of the user, and to input the base prompt sentence into a generative AI model so as to generate an artificial intelligence agent that imitates the characteristics of the user; to generate and store, in the memory, agent configuration information including identification information associated with the artificial intelligence agent and the base prompt sentence, and to read out the agent configuration information in response to a dialogue request from the terminal; to generate model input information by combining a natural-language prompt sentence received from the terminal with the agent configuration information, and to provide the model input information to the generative AI model so as to cause the generative AI model to generate a response sentence adapted to the attribute information of the user; to control the terminal to present, on the basis of the response sentence, options for supporting decision-making of the user and evaluation information regarding the options; and to perform safety and appropriateness post-processing on the response sentence and the evaluation information and to transmit a result of the post-processing to the terminal. This enables the server to technically improve orchestration of the generative AI model by separating and caching per-user agent configuration from per-interaction prompt sentences, by reducing redundant prompt construction and token processing, by dynamically adapting evaluation criteria and dialogue policies based on normalized attribute information and dialogue history, and by providing stable, context-aware decision support and conversational support, including caregiving-oriented interactions, with improved computational efficiency and controllability at the system level.

The term “processor” refers to a hardware computing element, such as a central processing unit or other execution circuitry, configured to execute instructions stored in a memory to perform operations of the system.

The term “terminal” refers to an information processing apparatus operated by a user, such as a mobile device, a portable computing device, or a stationary computing device, that communicates with the server over a communication network.

The term “user” refers to a human operator who provides input to the terminal and receives outputs from the system, including decision support information and conversational responses.

The term “attribute information” refers to information indicating characteristics of the user, including at least one of demographic information, preference information, activity information, or domain knowledge information, which is used to personalize behavior of an artificial intelligence agent.

The term “structured information” refers to attribute information that has been transformed into a machine-readable format having a defined schema, such as a record, an array, or a key-value data structure, suitable for storage and processing by the server.

The term “higher-level categories” refers to generalized classifications of attribute information, obtained by normalizing specific user attributes into broader conceptual groups, such as mapping detailed hobbies into abstract preference categories.

The term “normalize” refers to processing attribute information to convert heterogeneous or free-text values into standardized, canonical, or categorized values that are consistent across users and sessions.

The term “prompt sentence” refers to a sequence of natural-language tokens, or an equivalent representation, that is provided as input to a generative AI model in order to specify behavior, role, or constraints of the model or to request generation of a response.

The term “base prompt sentence” refers to a prompt sentence that encodes fundamental configuration information for an artificial intelligence agent, including definitions of user characteristics and intended usage purposes, and that is reused for multiple interactions with the same user.

The term “generative AI model” refers to a machine learning model, such as a statistical language model or neural network model, configured to generate text or other content in response to input data including a prompt sentence.

The term “artificial intelligence agent” refers to a logical entity implemented by the system using a generative AI model, the entity being configured to imitate characteristics of the user and to provide personalized decision support and conversational responses.

The term “agent configuration information” refers to information stored by the server that defines operational parameters of the artificial intelligence agent, including at least one of identification information, the base prompt sentence, normalized attribute information, and dialogue policies.

The term “identification information” refers to data, such as a unique identifier or key, that distinguishes one artificial intelligence agent or user from another within the system.

The term “recording medium” refers to any non-transitory computer-readable storage medium, such as a semiconductor memory, a magnetic storage device, or an optical storage device, capable of storing instructions or data used by the processor.

The term “dialogue request” refers to a request message transmitted from the terminal to the server, indicating that the user has initiated or continued an interaction and that the system is to generate a corresponding response using the artificial intelligence agent.

The term “natural-language prompt sentence” refers to a user-generated input expressed in a human language and provided from the terminal to the server, which is used as part of input information to the generative AI model.

The term “input information” refers to combined data supplied to the generative AI model, including at least the agent configuration information and the natural-language prompt sentence, and optionally additional context such as dialogue history.

The term “response sentence” refers to an output generated by the generative AI model in response to input information, the output being expressed as text or equivalent representation suitable for presentation to the user.

The term “decision-making support” refers to processing by which the artificial intelligence agent generates options and associated evaluation information to assist the user in selecting among alternatives.

The term “option” refers to a candidate choice or course of action presented to the user as part of decision-making support.

The term “evaluation information” refers to data indicating an assessment of an option, including at least one of predicted suitability, advantages, disadvantages, or priority, generated by the artificial intelligence agent.

The term “safety criteria” refers to predefined rules, policies, or models specifying conditions under which generated content is considered safe with respect to harm, illegality, or other restricted categories.

The term “appropriateness criteria” refers to predefined rules, policies, or models specifying conditions under which generated content is considered suitable in terms of context, politeness, relevance, or social norms.

The term “post-processing” refers to processing performed by the server on generated content, including filtering, modification, or annotation based on safety criteria and appropriateness criteria, before transmitting the content to the terminal.

The term “dialogue history” refers to stored information representing past exchanges between the user and the artificial intelligence agent, including prior user inputs and prior response sentences.

The term “evaluation criteria” refers to rules, weights, or parameters used by the artificial intelligence agent to assess or rank options as part of decision-making support.

The term “presentation formats” refers to styles or structures in which options, evaluation information, or response sentences are output to the user, including layout, level of detail, and terminology.

The term “caregiving environment” refers to a context in which the user is a person requiring care or support, such as an elderly person or a person with reduced independence, and in which the system is expected to provide emotionally supportive and accessible communication.

The term “dialogue policy” refers to a set of rules or parameters defining how the artificial intelligence agent should respond in a given context, including tone, complexity of language, pacing, and types of suggested actions.

The term “utterance content” refers to linguistic content of user speech or text supplied from the terminal to the server during an interaction.

The term “empathetic response sentence” refers to a response sentence generated by the generative AI model that is adapted to the user's emotional state and is designed to express understanding, reassurance, or emotional support.

In one embodiment, a server cooperates with multiple terminals operated by respective users to provide personalized decision support and conversational support based on a generative AI model. The server includes at least one processor, a main memory, a non-transitory storage device, and a network interface. The server may be implemented using general-purpose computing hardware, such as a rack-mounted computer with a central processing unit and a graphics processing unit, for example a multi-core CPU and a GPU suitable for machine learning inference. The server may execute an operating system such as a general-purpose server operating system and may run application software implemented as one or more server processes or services.

The terminal is an information processing apparatus operated by the user, such as a smartphone, a tablet, a laptop computer, or a desktop computer. The terminal includes a processor, a memory, a display, an input device such as a touch panel or keyboard, an audio input device such as a microphone, an audio output device such as a speaker or headset, and a communication module such as a wireless or wired network interface. The terminal runs an operating system such as a mobile or desktop operating system, and executes an application that presents an interface for the user to input attribute information and natural-language prompt sentences and to receive responses from the server.

In one configuration, the server stores and executes a program that causes the server to acquire user attribute information from the terminal, to normalize and store the attribute information, to generate a base prompt sentence that defines a per-user artificial intelligence agent, to interact with a generative AI model using the base prompt sentence and user-generated prompt sentences, and to transmit resulting response sentences and decision-support information to the terminal. The server may implement this program as a set of modules, for example a communication module, an attribute processing module, an agent configuration module, a model interaction module, a post-processing module, and a logging module.

The server acquires attribute information of the user from the terminal. The terminal causes a graphical user interface to be displayed on the display, including text input fields, selection boxes, and other controls. The user inputs attribute information such as age, gender, hobbies, and areas of expertise. For instance, the user may input: “age: 30,” “gender: male,” “hobbies: hiking and reading,” and “expertise: software engineering.” The terminal converts these inputs into a structured data representation, such as a record with fields for demographic information, preference information, and knowledge information, and transmits the structured data to the server via a communication network.

The server receives the structured attribute data via the network interface and stores the data in the memory or in a database maintained on the storage device. The server applies data normalization to the attribute information. In one example, the server executes attribute processing logic that maps low-level hobby descriptions into higher-level categories, such as mapping “hiking” into an “outdoor activity” category and “reading” into a “intellectual activity” category. The server maintains a category mapping table in storage and uses the processor to perform table lookups and to update a normalized attribute record. By converting heterogeneous free-text attributes into a standardized set of categories, the server reduces variation in conditioning inputs for the generative AI model, thereby improving prediction stability and allowing efficient reuse of configuration data across multiple inference calls.

The server generates a base prompt sentence for the generative AI model on the basis of the normalized attribute information. The agent configuration module on the server constructs a natural-language text that describes the user profile and defines the intended behavior of an such as:
“You are a personalized assistant for a user with the following profile: age 30, gender male, hobbies hiking and reading, expertise software engineering. You should provide decision support and conversational support that match this user's preferences and knowledge level, using friendly and concise language.”

In another example adapted to a caregiving environment, the server may generate a base prompt sentence such as:
“You are a gentle, patient conversational companion for an elderly user. The user is 78 years old, enjoys gardening and listening to music, and sometimes feels lonely. You should speak in simple, clear language, respond slowly, and provide emotional support during everyday conversation.”

The server stores the generated base prompt sentence together with associated configuration data as agent configuration information. The agent configuration information includes at least an agent identifier, the base prompt sentence, normalized attribute information, and one or more parameters specifying dialogue policies, such as preferred tone, level of detail, and allowed content categories. The server stores this agent configuration information in a non-transitory computer-readable storage, such as a database table keyed by the agent identifier and the user identifier.

The server interacts with a generative AI model using the base prompt sentence. In one embodiment, the generative AI model is implemented as a neural network in the form of a transformer architecture. The transformer includes multiple layers of self-attention blocks and feed-forward networks, each layer containing weight matrices, bias vectors, and non-linear activation functions. The model is trained beforehand on large-scale text data using a language modeling objective that minimizes a cross-entropy loss between predicted token distributions and ground-truth next tokens. During training, a learning algorithm such as stochastic gradient descent or an adaptive variant is used to update the weights based on the computed loss. The server may host the generative AI model in its own process, or may access an external inference service via an application programming interface.

The server encodes the base prompt sentence into token identifiers using a tokenizer that maps character sequences to subword units. The model interaction module loads the token sequence into model input tensors stored in GPU memory. The transformer architecture processes the tokens by computing attention scores among tokens, multiplying the tokens with learned weight matrices, and performing non-linear transformations to produce a sequence of output token distributions. The inference algorithm then samples or selects the most probable tokens according to parameters such as temperature and top-k or top-p settings. By reusing a persistent base prompt sentence for each user, the server reduces the need to repeatedly transmit and re-encode large portions of configuration text for every interaction, thereby reducing token count and computational overhead at the generative AI model.

The server constructs dialogue inputs to the generative AI model by combining the stored agent configuration information with newly received natural-language prompt sentences from the terminal. The user operates the terminal to input a natural-language query or statement. For example, the user may input a prompt sentence such as:
“Where should I go for my next vacation?”

As another example, the user in a caregiving scenario may input:
“I feel lonely today.”

The terminal transmits the prompt sentence and a session identifier to the server. The server retrieves the corresponding agent configuration information identified by the agent identifier or user identifier and concatenates or otherwise structures the base prompt sentence, any stored dialogue history, and the new prompt sentence into a model input context. For instance, the server may compose a text of the form:
“System: You are a personalized assistant for a user with the following profile: age 30, gender male, hobbies hiking and reading, expertise software engineering. You should provide decision support and conversational support that match this user's preferences and knowledge level, using friendly and concise language.
User: Where should I go for my next vacation?”

The server converts this context text into token sequences and forwards the tokens to the generative AI model for inference. The model processes both the base prompt portion and the user prompt portion in a single forward pass. By structuring the data in this way, the server allows the generative AI model to attend directly to both stable user characteristics and the latest query, which yields improved personalization quality and reduces the need for repeated manual tuning of prompts.

The server receives generated output token distributions from the generative AI model and reconstructs a response sentence as text. For example, given the above prompt, the model may generate a response sentence such as:
“Because you enjoy hiking and reading, I recommend visiting a mountain town with scenic trails and quiet cafés, where you can hike during the day and relax with a book in the evening.”

In the caregiving example, when the user inputs “I feel lonely today,” the model may generate:
“I am here with you. Would you like to talk about a happy memory, such as a favorite place you visited or a song you enjoy?”

The server applies post-processing logic to the generated response sentence. The post-processing module evaluates the content against safety criteria and appropriateness criteria. The module may implement rule-based filters, such as keyword lists and regular expressions, and may also apply classifier models trained to detect harmful or inappropriate content. The server may remove or replace text segments that violate safety policies, add disclaimers, or adjust formatting such as adding headings or line breaks. The post-processing also may adapt the language complexity to match the user's attribute information, for example simplifying vocabulary and shortening sentences for an elderly user in a caregiving environment.

The server derives decision-support information from the response sentence, or may directly instruct the generative AI model to output structured option and evaluation data. For example, the server may include in the prompt an instruction such as “List three options with pros and cons.” The model may then generate multiple options and associated evaluations. The server parses the generated text into structured option and evaluation records, which include candidate actions and corresponding suitability scores, advantages, and disadvantages. The server stores this information temporarily in memory and transmits it to the terminal.

The terminal receives the response sentence and the decision-support information, and updates the graphical user interface. The terminal presents the response sentence in a chat-style window and displays the options and evaluation data in a selectable format, such as a list of candidate items with brief explanations. When the user makes a selection, the terminal sends feedback to the server. The server records this feedback in dialogue history and may update evaluation criteria for future interactions with the same user.

In order to improve processing speed and reduce computation load, the server maintains a separation between per-user base prompt sentences and per-message prompt sentences. The agent configuration module caches the base prompt sentences in memory. For each interaction, the server only needs to append the latest user prompt sentence and a limited portion of dialogue history, instead of regenerating the base prompt text or retrieving and re-sending all user attributes. This reduces the number of tokens to be processed by the generative AI model and decreases the time required for each inference call. Empirically, this structure reduces average response latency and allows more simultaneous user sessions on the same hardware.

In one variation, the server dynamically adjusts evaluation criteria and presentation formats used by the artificial intelligence agent. The server observes dialogue history, including prior user choices and reactions, and modifies weights assigned to different decision factors, such as risk-averse versus adventurous preferences. These weights are stored as part of the agent configuration information. When computing or prompting for options, the server provides these weights to the generative AI model or applies them in a post-processing step that ranks options. This dynamic adjustment is performed by algorithmic rules and parameter updates on the server and is not merely manual configuration, which contributes to more accurate and consistent decision support while maintaining computational efficiency.

In a caregiving environment, the server augments the agent configuration information with a caregiving-specific dialogue policy. The dialogue policy includes parameters such as minimum and maximum sentence length, preferred sentiment level, avoidance of complex technical terms, and a preference to ask open-ended questions that encourage the user to speak about memories or feelings. The server inserts this dialogue policy into the base prompt sentence and stores the policy as structured data, such as numeric and categorical parameters, in the agent configuration information. During inference, the server passes these parameters as part of the model input or uses them to constrain decoding, for example by biasing sampling toward certain token types. This mechanism produces more predictable, supportive responses for elderly users and demonstrates a technical effect of controlling the generative AI model at a low level beyond simple textual guidance.

The generative AI model itself may use an encoder-decoder or decoder-only transformer architecture trained with supervised learning and optionally fine-tuned with reinforcement learning from human feedback. The server stores training metadata, including the loss function (e.g., cross-entropy), optimization algorithm, learning rate schedule, and training corpus description. The model is trained to minimize prediction error on next-token tasks and may further be fine-tuned on domain-specific dialogue data, such as caregiving dialogues or decision-support interactions. The server can load fine-tuned model checkpoints into memory to serve different types of agents. The training and deployment pipeline is designed so that the model generalizes to unseen users while being efficiently specialized at runtime through the agent configuration information.

The server achieves improved data management by maintaining explicit data structures for user profiles, normalized categories, agent configuration information, and dialogue histories. Each of these is stored in a database schema that supports indexing and retrieval based on identifiers and time stamps. The separation of concerns between attribute data and interaction data allows the server to update user preferences independently of ongoing conversations, and to reuse the same agent configuration across terminals used by the same user. This architectural design yields technical advantages including reduced storage redundancy, faster retrieval of configuration data, and reduced serialization overhead.

The described system provides more than mere automation of human tasks. The server reorganizes data and computation by introducing persistent, structured agent configuration information that is explicitly designed to cooperate with a generative AI model. This non-conventional use of a base prompt sentence and associated parameters, as a first-class configuration object cached and reused by the server, improves the internal operation of the computing system. The processor reduces redundant encoding and transmission, decreases latency, and increases throughput when serving multiple users concurrently. Further, by normalizing attribute data into higher-level categories and baking those categories into the base prompt design, the server reduces noise in model conditioning, which empirically improves response consistency and accuracy. These improvements arise from a specific arrangement of data structures, control logic, and model interaction methods that are implemented at the server and cannot be achieved by merely performing the same steps mentally or manually.

In alternative embodiments, the server may host different generative AI models with varying sizes, architectures, or training objectives. For users with limited network bandwidth or requiring low latency, the server may select a smaller model and generate a compact base prompt sentence to further reduce inference time. For users in a caregiving environment, the server may select a model fine-tuned on caregiving dialogues and may adjust the decoding parameters to favor safer and more empathetic text. The agent configuration information includes a model selection field, enabling the server to route requests to different back-end models depending on user attributes and system load.

The terminal may further support speech-based interaction by converting audio signals into text and vice versa. The terminal uses a speech recognition engine to convert the user's spoken words into a natural-language prompt sentence and transmits the text to the server.

The terminal also receives the response sentence and uses a text-to-speech engine to generate audio output. This configuration allows the system to be deployed in environments where text input is difficult, such as for users with visual impairment or reduced motor function. In such cases, the server's ability to maintain a stable agent configuration and to reliably generate predictable, supportive responses is particularly valuable.

These embodiments and variations illustrate that the server, the terminal, and the generative AI model are combined in a specific, technically grounded manner, resulting in improvements to processing speed, personalization accuracy, data management, and system-level efficiency that go beyond simple automation of human decision-making or conversation.

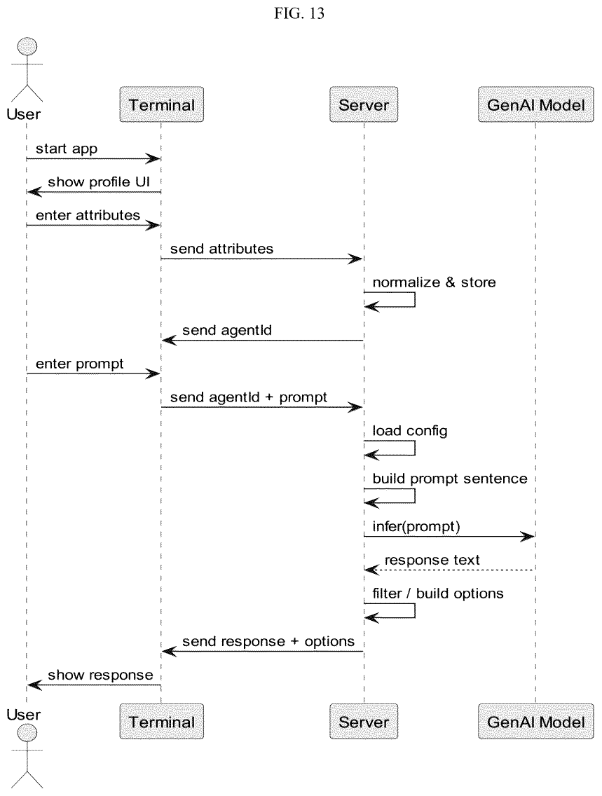

The following describes the processing flow using FIG. 13.

### Step 1:

The user operates the terminal to start an application for profile setup.
The input to this step is a user action, such as tapping an application icon or selecting a menu item.
The terminal loads application code from its local storage into memory, initializes user interface components, and displays a screen containing input fields for attribute information.
The output of this step is a rendered graphical user interface including text boxes, selection controls, and buttons for attribute entry.

### Step 2:

The user inputs attribute information into the terminal's user interface.
The input to this step is the attribute information that the user provides, such as age, gender, hobbies, and areas of expertise.
The user touches text boxes to activate the software keyboard, types values such as “30” for age and “male” for gender, and selects hobbies such as “hiking” and “reading” using checkboxes or drop-down lists. The terminal captures each keystroke and selection event and stores the values in temporary variables. The output of this step is a set of raw attribute values held in the terminal's memory.

### Step 3:

The terminal validates and structures the attribute information.
The input to this step is the set of raw attribute values obtained in Step 2.
The terminal executes validation logic that checks data types (for example, age must be a positive integer), required fields (for example, gender must not be empty), and allowed ranges. If invalid data is detected, the terminal displays error messages and requests correction. After validation succeeds, the terminal converts the values into a structured record, for example by mapping each UI field to a key and converting lists of hobbies into arrays. The output of this step is a structured attribute record suitable for transmission, held in the terminal's memory.

### Step 4:

The terminal transmits the structured attribute record to the server.
The input to this step is the structured attribute record from Step 3.
The terminal serializes the record into a format such as a JSON string, opens a network connection using a secure protocol, and embeds the serialized data in a request message. The terminal's communication module sends the message through the communication network to a predefined server endpoint. The output of this step is a network request containing the structured attribute record that arrives at the server's network interface.

### Step 5:

The server receives and parses the structured attribute record.
The input to this step is the network request containing the serialized attribute data from Step 4.
The server's network interface accepts the request, and the server's communication module extracts the payload and decodes the serialized format into an internal data structure, such as a dictionary or object with fields for age, gender, hobbies, and expertise. The server may perform additional validation to ensure that the received data conforms to expected types and constraints. The output of this step is a validated attribute data structure stored in the server's memory.
Step 6:
The server normalizes the attribute information into higher-level categories.
The input to this step is the validated attribute data structure from Step 5.
The server accesses a normalization table or rule set stored in a database or configuration file, which maps specific values such as “hiking” to broader categories such as “outdoor activity” and “reading” to “intellectual activity.” The server iterates through each attribute field, looks up corresponding entries in the normalization table, and replaces or augments the original values with category labels. The data processing performed here is a mapping operation and a re-encoding of attribute values into a reduced set of standardized categories. The output of this step is a normalized attribute record that includes both original values and higher-level categories.

### Step 7:

The server stores the normalized attribute record and links it to a user identifier.
The input to this step is the normalized attribute record from Step 6 and a user identifier associated with the session.

The server constructs a database command that inserts or updates a record in a user profile table, including fields for the user identifier, raw attributes, normalized categories, and timestamps. The server executes this command using a database interface, and the database writes the data to non-transitory storage. The output of this step is a persistent user profile entry containing normalized attribute information, retrievable by the user identifier.

### Step 8:

The server generates a base prompt sentence for an artificial intelligence agent.
The input to this step is the normalized attribute record from Step 6.

The server's agent configuration module constructs a text string by concatenating fixed template phrases with attribute values. The server may execute string formatting operations such as inserting “age 30,” “gender male,” “hobbies hiking and reading,” and related categories into pre-defined sentence patterns. For example, the server may generate a base prompt sentence such as:
“You are a personalized assistant for a user with the following profile: age 30, gender male, hobbies hiking and reading, expertise software engineering. You should provide decision support and conversational support that match this user's preferences and knowledge level, using friendly and concise language.”

The output of this step is the base prompt sentence stored as a text object in the server's memory.

### Step 9:

The server constructs agent configuration information and stores it.
The input to this step is the base prompt sentence from Step 8 and the normalized attribute record from Step 6.

The server generates a new agent identifier, for example by computing a unique value based on the user identifier and a sequence counter. The server then creates an agent configuration object that includes the agent identifier, the base prompt sentence, the normalized attributes, and additional parameters such as preferred tone and maximum response length. The server writes this agent configuration object into an agent configuration table in the database. The output of this step is a persistent agent configuration entry, addressable by the agent identifier.

### Step 10:

The server returns the agent identifier to the terminal.
The input to this step is the newly created agent configuration entry from Step 9.

The server constructs a response message that includes the agent identifier and optional status information, encodes it into a serialized format such as JSON, and sends it through the network interface back to the terminal. The output of this step is a network message containing the agent identifier that arrives at the terminal's communication module.

### Step 11:

The terminal receives and stores the agent identifier.
The input to this step is the network response from Step 10 containing the agent identifier.

The terminal decodes the response, extracts the agent identifier, and writes the identifier into local storage associated with the application, such as a preferences store or local database. The terminal then updates its user interface to transition from the profile input screen to a dialogue screen. The output of this step is a stored agent identifier on the terminal and a rendered chat interface ready to accept natural-language prompt sentences.

### Step 12:

The User inputs a natural-language prompt sentence for interaction with the artificial intelligence agent.
The input to this step is the user's intention to ask a question or start a conversation.

The user types a prompt sentence into a text input area, such as “Where should I go for my next vacation?” or, in a caregiving context, “I feel lonely today.” The terminal captures the text and may optionally include metadata such as a timestamp. The output of this step is a user prompt string stored in the terminal's memory.

### Step 13:

The terminal packages the prompt sentence and related context for transmission.

The input to this step is the user prompt string from Step 12 and the agent identifier stored in Step 11.

The terminal constructs a structured request that includes the agent identifier, the user identifier, the current prompt sentence, and optionally a subset of recent dialogue history kept locally. The terminal serializes this structure into a format such as JSON and adds network headers specifying the destination endpoint. The output of this step is a serialized request payload containing the prompt sentence and agent context.

### Step 14:

The terminal sends the prompt request to the server.
The input to this step is the serialized request payload from Step 13.

The terminal's communication module initiates a secure session, writes the payload to the network socket, and transmits the data through the communication network. The output of this step is a network message received by the server's network interface that contains the prompt sentence and the agent identifier.

### Step 15:

The server retrieves agent configuration information based on the agent identifier.
The input to this step is the request from Step 14, including the agent identifier and the user prompt sentence.

The server parses the request, extracts the agent identifier, and issues a query to the agent configuration table in the database. The database returns the stored agent configuration object, including the base prompt sentence and normalized attributes. The server loads this configuration into memory. The output of this step is an in-memory agent configuration object associated with the user's artificial intelligence agent.

### Step 16:

The server combines the base prompt sentence and the user prompt sentence into model input text.
The input to this step is the agent configuration object from Step 15 and the user prompt sentence from Step 14.

The server assembles a composite text that includes the base prompt sentence, markers specifying the roles (for example, system and user), optional dialogue history, and the latest user prompt. The server may structure the text as:
“System: [base prompt sentence]
User: [user prompt sentence]”
The server performs string concatenation and formatting operations to ensure that the resulting text respects the generative AI model's expected input format. The output of this step is a complete model input text string.

### Step 17:

The server transforms the model input text into token sequences for the generative AI model.
The input to this step is the model input text string from Step 16.

The server applies a tokenizer associated with the generative AI model that maps character sequences into integer token identifiers. The tokenizer splits the text into subword units, assigns each unit an identifier, and generates an ordered list of identifiers. The server then constructs numerical tensors or arrays from these identifiers, suitable for input to the transformer network. The output of this step is a tokenized representation of the input text in the form of numerical data structures.

### Step 18:

The server performs inference on the generative AI model using the token sequences.
The input to this step is the tokenized representation from Step 17.

The server loads the tokens into GPU or CPU memory, and the generative AI model processes them through multiple transformer layers. Each layer performs matrix multiplications between token embeddings and learned weight matrices, computes attention scores between tokens, and applies non-linear activations and normalization operations. The server controls parameters such as maximum output length, temperature, and sampling strategy. The numerical operations progressively produce probability distributions over possible next tokens at each time step. The output of this step is a sequence of predicted token identifiers representing the generated response.

### Step 19:

The server decodes the generated token identifiers into a response sentence.
The input to this step is the sequence of predicted token identifiers from Step 18.

The server applies a detokenizer that maps each token identifier back to its corresponding text fragment and concatenates these fragments into a coherent text string. The server may trim or adjust whitespace and punctuation to form correctly formatted sentences. The output of this step is a response sentence in natural language, for example:
“Because you enjoy hiking and reading, I recommend visiting a mountain town with scenic trails and quiet cafes, where you can hike during the day and relax with a book in the evening.”

### Step 20:

The server applies safety and appropriateness post-processing to the response sentence.
The input to this step is the response sentence from Step 19 and, optionally, user attribute information and dialogue context.

The server evaluates the text against a set of rules and classifier outputs. The server may scan for prohibited terms using pattern matching, run a content moderation model to detect harmful categories, and adjust sentence complexity based on user age. If the response contains content that violates safety or appropriateness criteria, the server modifies or replaces the problematic portions. The server may also insert additional clarifying phrases or warnings. The output of this step is a sanitized and context-appropriate response sentence.

### Step 21:

The server derives decision-support options and evaluation information, if requested.
The input to this step is the sanitized response sentence from Step 20 and instructions from the agent configuration or the current prompt indicating that options should be generated.

The server parses the response or instructs the generative AI model in an earlier step to structure the output as multiple options. The server then extracts each option, and any associated evaluation information such as advantages, disadvantages, or suitability scores. This may involve text parsing, pattern recognition, or additional calls to the model with targeted prompts. The output of this step is a set of structured option records and associated evaluation data.

### Step 22:

The server transmits the response sentence and decision-support information to the terminal.

The input to this step is the sanitized response sentence from Step 20 and the structured options and evaluations from Step 21.

The server packages these data into a response message, encodes it into a serialization format, and sends it over the network to the terminal. The output of this step is a network message that reaches the terminal, containing the AI-generated response and optional decision-support structures.

### Step 23:

The terminal receives the server response and updates the user interface.
The input to this step is the response message from Step 22.

The terminal decodes the message, extracts the response sentence and the list of options with evaluations, and renders them on the display. The terminal appends the response sentence to a chat window, formats the options as selectable items, and scrolls the display to show the most recent interaction. The output of this step is an updated visual presentation that the user can read and interact with.

### Step 24:

The user reviews the response and optionally selects an option or inputs a follow-up prompt sentence.
The input to this step is the visual presentation produced in Step 23.

The user reads the response and the options, evaluates them, and may tap one of the options to indicate a choice or type a follow-up query such as “Please suggest a 3-day itinerary in that mountain town” or, in a caregiving context, “Can you tell me a story from the past?” The terminal captures this selection or new prompt and prepares it for transmission back to the server. The output of this step is either a user selection or a new natural-language prompt sentence, which re-enters the processing flow starting from the relevant terminal-side steps.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented dialogue systems and decision support systems, the processing logic typically treats user inputs as isolated queries and applies fixed response rules or static prompt settings to generative AI models. Such systems suffer from several technical limitations. First, the system cannot robustly maintain and exploit a structured user profile that combines heterogeneous data such as attribute information, past behavior information, and emotional patterns in a unified, machine-usable representation. As a result, the system is unable to adapt the internal control signals, including prompt sentences to a generative AI model, in a way that reflects long-term user-specific context. This leads to suboptimal use of computational resources of the AI engine and reduced consistency in response behavior across sessions.

Second, conventional systems generally apply sentiment analysis or emotion detection only as a post-processing filter for outputs, without integrating the emotion estimation into the core control flow of the model invocation. The prompt or control context supplied to the generative AI model is typically static or only loosely tied to emotion data, thereby failing to dynamically modulate the generative behavior based on real-time emotional state changes. This can cause instability in response quality and necessitate additional client-side or server-side corrective logic, increasing system complexity and latency.

Third, existing systems often lack a unified server-side mechanism for continuously updating evaluation criteria for decision options, based on both emotion estimation results and historical selection behavior, and for regenerating persona-related prompt sentences in a structured, automated manner. As a consequence, the system cannot effectively refine the internal agent configuration over time, which degrades the technical performance of the dialogue engine, including personalization accuracy, convergence of option scoring, and predictability of generated responses.

Fourth, in distributed environments such as care environments and security environments, many systems rely on loosely coupled components for speech recognition, emotion estimation, and generative response, with limited orchestration on the server side. This fragmented architecture can lead to increased network traffic, duplicative computation, and higher end-to-end response latency, especially when handling real-time abnormal emotion detection and alert generation. There is a need for a server-centric architecture in which the processor manages acquisition of user information, generation and regeneration of prompt sentences, invocation of a generative AI model, emotion estimation, and alert control in an integrated processing pipeline.

Accordingly, there is a demand for an improved computer-implemented system that (i) generates and maintains an abstracted and normalized user profile, (ii) produces and dynamically updates prompt sentences supplied to a generative AI model based on both the user profile and real-time emotion estimation, (iii) continuously adjusts option evaluation criteria and persona configuration of the dialogue model based on historical behavior, and (iv) performs integrated speech recognition, emotion-aware response generation, and abnormal emotion alerting on the server side. Such a system should improve the technical operation of the computer by enhancing the control of the generative AI model, reducing redundant processing, and providing more stable and efficient decision support and dialogue functions.

The specific processing by the specific processing unit 290 of the data processing device 12 in Application Example 2 is realized by the following means.

The present invention provides a server comprising a processor and a storage unit, the processor being configured to acquire user information including attribute information and past behavior information of a user, generate a user profile comprising the attribute information and the past behavior information and perform abstraction and normalization of the user profile, generate a prompt sentence on the basis of the user profile, the prompt sentence being configured to set, in a generative AI model, an information processing target that imitates a personality of the user, input the prompt sentence into the generative AI model to construct a dialogue processing information processing model that imitates the personality of the user and store the dialogue processing information processing model in the storage unit in association with an agent setting for the user, execute a decision support process by using the dialogue processing information processing model to generate response information to inquiry information acquired from the user, the response information including presentation of a plurality of options and generation of evaluation information for the plurality of options on the basis of the user profile, analyze natural language data included in the inquiry information and estimate an emotional state of the user by performing an emotion estimation process, dynamically change a prompt sentence to be given to the dialogue processing information processing model in accordance with the emotional state and the user profile and adjust content and an expression format of the response information generated by the dialogue processing information processing model, and, when the emotional state is determined to be an abnormal state exceeding a predetermined criterion, generate warning information for the user or notification information for a management terminal. This enables the computer system to internally manage an evolving user-specific agent configuration and to control the generative AI model through dynamically updated prompt sentences that reflect both long-term user profiles and real-time emotional states, thereby improving the technical operation of the server-side dialogue engine, reducing latency and redundant processing, and enhancing stability and effectiveness of decision support and real-time interactive responses in care and security environments.

The term “user information” refers to data associated with an individual user, including at least attribute information and past behavior information, which is acquired and stored by the system for use in generating and updating a user profile.

The term “attribute information” refers to descriptive data indicating characteristics of a user, such as age, gender, preferences, interests, expertise, occupation, or similar personal attributes that can be used to model the user's personality and tendencies.

The term “past behavior information” refers to data representing historical actions, selections, or interactions of a user with the system or related services, including past choices among options, prior queries, and usage patterns, which are used to refine personalization and evaluation criteria.

The term “user profile” refers to a structured data representation that combines attribute information and past behavior information for a user, and that is processed into a form suitable for computational analysis and control of an information processing model.

The term “abstraction and normalization of the user profile” refers to processing operations that generalize, standardize, and clean raw user information, including operations such as categorization, value normalization, removal of noise, and mapping to higher-level feature representations, so that the resulting profile can be consistently interpreted by the processor and the generative AI model.

The term “prompt sentence” refers to a machine-readable natural language instruction or control text generated by the processor, which encodes conditions, constraints, and persona-related information, and which is supplied as input to a generative AI model to configure an information processing target.

The term “generative AI model” refers to an information processing model that generates output data, such as natural language text, in response to input data, by using statistical or machine learning techniques, including but not limited to neural network-based language models.

The term “information processing target that imitates a personality of the user” refers to a logical configuration or internal state of the generative AI model that is parameterized to behave in a manner similar to the user's personality, including preferred styles of reasoning, speaking, and selecting options.

The term “dialogue processing information processing model” refers to a configuration of the generative AI model, determined by at least one prompt sentence and associated parameters, which is used to generate responses in a conversational format for interactions with the user.

The term “agent setting” refers to configuration data associated with a particular user, including at least one prompt sentence, model parameters, and control settings, which together define how the dialogue processing information processing model should operate for that user.

The term “storage unit” refers to one or more physical or logical data storage resources, such as memory devices or databases, configured to store user profiles, agent settings, prompt sentences, dialogue processing information processing models, and log data.

The term “inquiry information” refers to data representing a request, question, or statement provided by the user to the system, including text-based input and voice-based input that is converted into character information, which is processed by the dialogue processing information processing model.

The term “response information” refers to data generated by the dialogue processing information processing model in reply to the inquiry information, including natural language text or other structured content that can be rendered to the user or used internally.

The term “decision support process” refers to a sequence of processing operations in which the dialogue processing information processing model generates response information that includes presentation of a plurality of options and evaluation information for the options, thereby assisting the user in making a selection or judgment.

The term “option” refers to a candidate choice, recommendation, or course of action presented to the user in the decision support process, which may be evaluated and compared by the system.

The term “evaluation information” refers to data representing an assessment or scoring of each option, derived based on the user profile or related criteria, and used to indicate relative suitability, priority, or desirability of the options.

The term “evaluation criteria” refers to rules, weights, thresholds, or other computational parameters used to compute evaluation information for options, where such criteria may be updated over time based on user behavior and emotional states.

The term “emotion estimation process” refers to an information processing operation that analyzes natural language data or related signals to estimate an emotional state of the user, such as stress, joy, anger, sadness, or similar affective conditions.

The term “emotional state” refers to an estimated psychological or affective condition of the user, represented as one or more labels and associated intensities, which is derived from analysis of inquiry information or other user signals.

The term “abnormal state” refers to an emotional state determined by the processor to exceed a predetermined criterion or threshold, indicating a condition such as heightened stress, extreme anger, or other atypical or risky affective patterns that require special handling or alerts.

The term “warning information” refers to data generated by the processor and addressed to the user to indicate that an abnormal state has been detected, and to provide caution, guidance, or supportive messages in response.

The term “notification information” refers to data generated by the processor and addressed to a management terminal or another supervisory device, indicating occurrence of an abnormal state or other notable event, and enabling intervention or monitoring by a human operator.

The term “management terminal” refers to an information processing device operated by a supervisor, caregiver, security personnel, or other administrator, which is configured to receive notification information and, optionally, to display or further process such information.

The term “dynamically change a prompt sentence” refers to modifying, regenerating, or augmenting a prompt sentence at run time based on current conditions, including at least the emotional state and the user profile, so that subsequent invocations of the generative AI model are controlled by updated instructions.

The term “expression format of the response information” refers to stylistic and structural aspects of the generated response, including tone, politeness level, verbosity, language choice, and output modality, which can be adjusted independently of the substantive content.

The term “past selection history” refers to records of options previously selected by the user in decision support processes, including timestamps, contexts, and associated evaluation information, which are used to refine future evaluation criteria and agent settings.

The term “speech recognition process” refers to an information processing operation that converts voice information, acquired for example via a microphone, into character information that can be treated as natural language text by the system.

The term “speech synthesis process” refers to an information processing operation that converts character information, such as response information generated by the dialogue processing information processing model, into voice information suitable for audio output.

The term “care environment” refers to a physical or virtual environment in which users receive assistance or care, such as elder care or medical support, and in which the system provides emotion-aware dialogue responses and decision support.

The term “security environment” refers to a physical or virtual environment related to monitoring, access control, or risk management, in which the system uses emotion-aware dialogue responses and alerting functions to assist in maintaining safety and security.

In one embodiment, a server cooperates with one or more terminals operated by a user to implement a system as set forth in the claims. The server includes at least one processor, a main memory, and a non-volatile storage device such as a relational database system. The terminal includes at least one processor, a display unit, an input unit such as a touch panel or keyboard, a microphone, a loudspeaker, and a communication interface for connecting to the server via a network such as the Internet.

The terminal executes an application program, for example a web browser or a native client application, which presents a graphical user interface to the user. The user operates the terminal to input user information including attribute information and past behavior information. The attribute information includes generalized descriptive features such as age, gender, categories of preferences, categories of interests, and domains of expertise. The past behavior information includes historical selections among options, historical queries, and interaction logs. The terminal converts these inputs into structured data in an internal data structure and transmits the structured data to the server via a secure communication protocol such as HTTPS.

The server receives the user information and stores it in a storage unit such as a relational database management system. The server uses a data schema in which each user is assigned a unique identifier, and each record of attribute information and past behavior information is normalized into tables or collections with foreign keys or references to the user identifier. The server executes software implemented for example in a general-purpose programming language to perform abstraction and normalization of the user information. The server maps raw textual inputs for hobbies and interests into higher-level categories using a natural language processing library, such as a tokenization engine and a category classifier, and stores the abstracted features as feature vectors. The server thereby generates a user profile including an abstracted feature vector and normalized attribute values.

The server generates a prompt sentence on the basis of the user profile. The server prepares a prompt template including fields for age, general preference categories, expertise domains, and behavioral tendencies inferred from the past behavior information. The server fills the template with the corresponding elements of the user profile to produce a natural-language control string. In one example, the server generates a prompt sentence of the following form: “The user is a 30-year old person who prefers nature-related activities and reading and has expertise in information technology. Configure a generative AI model to imitate this user's personality and typical decision-making style. The model should prioritize options that match nature-related activities and intellectually stimulating content, and should explain reasons in a concise and polite manner.”

In another example, the server generates a prompt sentence such as: “The user is an 80-year-old person living in an assisted living environment, who enjoys gardening and classical music and often feels lonely. Configure a generative AI model as a gentle, supportive companion that speaks slowly, uses simple expressions, and proposes daily activities that are physically light and emotionally comforting.”

The server supplies the prompt sentence to a generative AI model provided by a separate computing resource. The generative AI model is a neural network-based language model including multiple transformer layers with self-attention mechanisms, trained on a large corpus of text data by minimizing a next-token prediction loss. The model includes parameters such as layer weights, layer normalization coefficients, and attention matrices. During inference, the model receives as input a tokenized representation of the prompt sentence and subsequent conversational turns and outputs probability distributions for subsequent tokens, from which output text is generated.

The server configures the generative AI model into a dialogue processing information processing model by designating the prompt sentence as a system-level instruction or context. The server associates the prompt sentence, model selection, and control parameters such as temperature and maximum output length with the user identifier and stores this association as an agent setting in the storage unit. By storing the agent setting, the server enables subsequent reuse of the same persona-related configuration without reconstructing the profile from scratch for each query, which reduces computation and network usage.

The server receives inquiry information from the terminal. The user provides inquiry information by speaking into the microphone or by entering text into an input field. The terminal converts voice signals acquired by the microphone into text using a speech recognition engine executing on the terminal or via a network-accessible speech recognition service. The speech recognition engine applies an acoustic model and a language model to decode the audio stream into character sequences and transmits the resulting text to the server as inquiry information.

The server analyzes the inquiry information using a natural language processing pipeline. The server uses a tokenizer to divide the text into tokens and applies an emotion classification model to estimate an emotional state of the user. The emotion classification model can be implemented as a neural network classifier that receives token embeddings as inputs and outputs one or more emotion labels such as stress, joy, anger, and sadness, together with confidence scores. The server compares the confidence scores against predetermined thresholds to determine whether an abnormal state exists. For example, when a score for stress exceeds a threshold, the server determines that the emotional state is abnormal.

The server dynamically changes a prompt sentence supplied to the dialogue processing information processing model according to the estimated emotional state and the user profile. The server generates an augmented prompt sentence by adding emotion-related control instructions to the persona-related instructions. For example, when the emotional state indicates stress, the server appends a clause such as:
“The user currently appears to be under high stress. Respond in a calm and reassuring tone, avoid overwhelming detail, and provide brief, supportive suggestions.”

When the emotional state indicates joy, the server appends a different clause such as:
“The user currently appears to be in a positive mood. Use a friendly tone and reinforce the user's positive feelings while still providing accurate and concise information.”

By constructing such augmented prompt sentences, the server modifies the control context of the generative AI model at run time. This dynamic control changes the behavior of the generative AI model in a way that depends on the current input and stored profile, which is a nonconventional use of the model. The server then inputs the augmented prompt sentence together with the inquiry information into the generative AI model, which generates response information.

The server uses the dialogue processing information processing model to generate response information including presentation of a plurality of options and evaluation information for the options, based on the user profile. The server prepares a prompt sentence for decision support purposes, for example: “The user has previously selected beach-related destinations for vacations and tends to avoid crowded urban areas. Propose three travel destinations. For each destination, provide a brief explanation of why it matches the user's preferences, and assign a suitability score from 0 to 100, where a higher score indicates a better match.”

The generative AI model then outputs candidate destinations and associated explanations and scores. The server parses this output and structures it as options and evaluation information. The server stores the selected option and evaluation information in the storage unit as part of the past behavior information.

The server periodically updates evaluation criteria for options. The server analyzes the stored history of past selections and associated contexts using statistical methods or machine learning techniques. For example, the server calculates correlations between underlying features of options and whether the user actually selected those options. The server then adjusts weights in the evaluation criteria so that features more strongly associated with selected options receive higher weights. The server integrates such weights into future prompt sentences, thereby regenerating prompt sentences that instruct the generative AI model to emphasize or de-emphasize certain attributes. This feedback mechanism results in gradual convergence of personalization, improves evaluation accuracy, and reduces the number of iterations required for the user to reach a satisfactory decision.

The server determines, when an abnormal emotional state is detected, whether to generate warning information for the user or notification information for a management terminal. When the server generates warning information, the server uses the dialogue processing information processing model to produce supportive or cautionary expressions, such as:
“You seem very stressed at the moment. Let us slow down. Would you like to take a short break or hear some simple relaxation tips?”

When the server generates notification information, the server transmits structured alert data to a management terminal operated by a caregiver or security personnel. The management terminal displays the alert together with relevant context such as the estimated emotion label and time stamp. This configuration enables timely human intervention in care environments or security environments.

The terminal presents the response information to the user. The terminal receives textual response information from the server, renders it on the display, and optionally converts it into synthetic speech using a text-to-speech engine executing on the terminal or on a network-accessible service. The terminal applies voice synthesis techniques to generate audio waveforms that are output through the loudspeaker. The user can thus receive both visual and auditory responses without manually interpreting complex textual output.

This architecture provides specific technical improvements over conventional systems. Because the server performs abstraction and normalization of user profiles and stores profile features in a structured manner, the server can efficiently reuse and update the profiles without recomputing all features for each query. This reduces processor usage and memory bandwidth. Because the server dynamically constructs and updates prompt sentences based on both profiles and emotion estimates, rather than using static prompts, the system reduces the need for repeated client-side adjustments and minimizes redundant round trips. The server thereby decreases network traffic and improves response latency.

Additionally, by coupling the emotion estimation process with the control of the generative AI model inside the server, the system achieves more stable and predictable generative outputs. The server enforces consistent emotion-aware control rules at the prompt-construction stage, which reduces variation in generated responses and lowers the need for post-filtering. This improves computational efficiency because the server avoids generating and then discarding unsuitable responses.

The use of a transformer-based generative AI model with a stored persona configuration and dynamic prompt adjustment is also technically distinct from simple rules-based decision trees or manual scripting. The server forms a layered control path: a persistent agent setting that encodes long-term persona, and a transient emotion-based augmentation that encodes short-term state. This layered control allows the generative AI model to operate within a constrained, user-specific region of its parameter space, which improves accuracy and reduces the probability of producing irrelevant outputs. The reduction of irrelevant outputs directly contributes to fewer retries and less total computation.

In another embodiment, the server uses different generative AI models for different environments. For a care environment, the server may use a model variant that is optimized for empathetic and slow-paced dialogue, with parameters tuned for longer context windows and more conservative sampling. For a security environment, the server may use a model variant that is tuned for concise instructions and rapid detection of risk-related language patterns, including keyword-triggered modifications of evaluation criteria. The server selects the appropriate model variant based on environment information and incorporates this selection into the agent setting.

In a further embodiment, the server executes the emotion estimation process using a separate neural network model, such as a bidirectional recurrent neural network or a transformer encoder trained on labeled emotion data. The server trains this model using supervised learning, by minimizing a cross-entropy loss between predicted emotion labels and ground truth labels, and updates weight parameters via gradient-based optimization. The server can perform such training offline and deploy trained parameters to the production environment. The server can also periodically refresh the model based on new anonymized logs to adapt to changing language usage patterns, which improves emotion estimation accuracy and, consequently, the effectiveness of dynamic prompt modification.

In another variation, the terminal performs some preprocessing to improve overall system performance. For example, the terminal can perform local caching of recent responses and local computation of lightweight feature extraction, such as keyword detection, before sending inquiry information to the server. The terminal can embed such features as metadata in the request. The server can use these features to reduce computation in the emotion estimation and decision support processes. This division of labor further reduces server load and network traffic.

In yet another embodiment, the server compresses prompt sentences and agent settings when storing them in the storage unit, using a text compression algorithm. The server decompresses the data on demand when reconstructing the dialogue processing information processing model. This compression reduces storage requirements and accelerates input/output operations, which contributes to faster overall processing and improved scalability when many users are served simultaneously.

In all these embodiments, the system does not merely automate human mental tasks. Instead, the system modifies internal data structures and control flows of a computer system to more efficiently manage complex, multi-dimensional user profiles and to fine-tune the behavior of a generative AI model at run time according to quantifiable emotional and behavioral signals. The system thereby improves the functioning of the computer itself, including processing efficiency, response stability, data management, and network utilization, and provides a technical implementation that can be practically realized on general-purpose or specialized computing hardware.

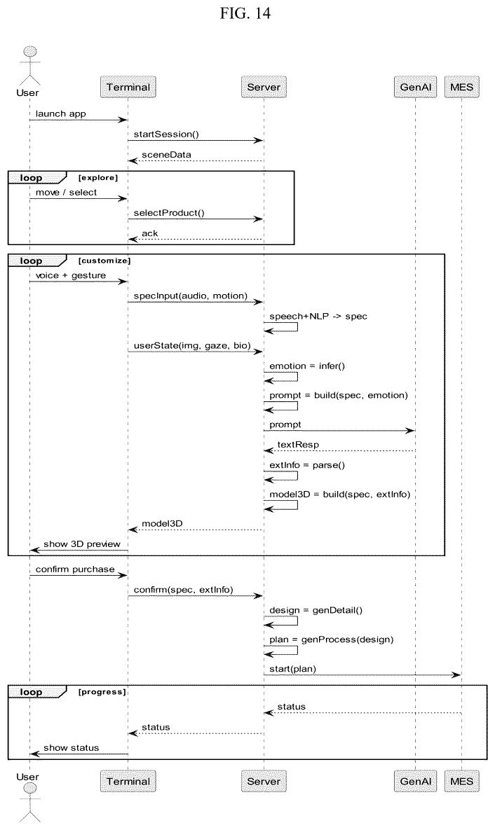

The following describes the processing flow using FIG. 14.

### Step 1:

User operates the terminal to input user information.
User views an input screen on the terminal and enters attribute information such as age, gender, general preferences, interests, and expertise, and optionally past behavior information such as previous choices or activities.
Input: raw attribute values and free-text descriptions entered via a touch screen or keyboard.

Terminal validates mandatory fields and data types (for example, that age is a number and required fields are not empty), then packs the inputs into an internal data structure. Terminal sends the structured user information to the server over a secure network connection.

Output: structured user information transmitted to the server.

### Step 2:

Server receives and stores the user information.
Server accepts an incoming network request containing the structured user information and parses it using a server-side framework.
Input: structured user information from the terminal.
Server verifies user identity or assigns a new user identifier, then writes the attribute information and initial past behavior information into a storage unit such as a relational database, using normalized tables linked by a user ID. Server records timestamps and source terminal identifiers to support later analysis.
Output: stored user records and an associated user identifier.

### Step 3:

Server generates an abstracted and normalized user profile.
Server retrieves the newly stored user records and applies data processing routines to unify formats and abstract raw values.
Input: raw database records for attribute information and any available past behavior information.
Server applies operations such as lowercasing text, trimming spaces, mapping free-text hobbies to category codes using a lookup table, and computing a feature vector summarizing preferences and tendencies. Server then stores this abstracted and normalized profile as a user profile object associated with the user identifier.
Output: an abstracted, normalized user profile ready for use in prompt generation.

### Step 4:

Server generates a base persona prompt sentence from the user profile.
Server reads the user profile object and inserts its elements into a prepared prompt template.
Input: user profile containing normalized attributes (for example, age, preference categories, expertise domains) and behavioral features.

Server concatenates textual fragments and replaces template placeholders with profile values to produce a persona description. For example, the server generates a prompt sentence such as:
“The user is a 30-year-old person who prefers nature-related activities and reading and has expertise in information technology. Configure a generative AI model to imitate this user's personality and typical decision-making style. The model should prioritize options that match nature-related activities and intellectually stimulating content, and should explain reasons in a concise and polite manner.”
Server then stores this base persona prompt sentence in association with the user identifier.
Output: a base persona prompt sentence stored as part of an agent setting.

### Step 5:

Server configures a dialogue processing model in the generative AI model.
Server uses the base persona prompt sentence to define an agent setting in the generative AI model.
Input: base persona prompt sentence and model configuration parameters such as model name, temperature, and maximum token length.
Server sends a configuration request to the generative AI model, including the prompt sentence as a system or initial message, and registers the resulting configuration token or context handle. Server stores this association (user ID, prompt sentence, model parameters, context handle) in the storage unit as an agent setting.
Output: a dialogue processing model configuration associated with the user.

### Step 6:

User issues an inquiry through the terminal.
User opens a conversation screen on the terminal and inputs a question or request, for example by typing “Where should I go for my next vacation?” or by speaking into the microphone.
Input: raw text from a text field or audio signals captured by the microphone.
Terminal converts audio signals into text using a speech recognition engine, then bundles the text query and user identifier into a request message. Terminal transmits the inquiry information to the server using a predefined API.
Output: inquiry information (text form) sent to the server.

### Step 7:

Server performs emotion estimation from the inquiry information.
Server receives the inquiry information and extracts the text portion for analysis.
Input: text representing the user's inquiry.
Server applies a natural language processing pipeline: it tokenizes the text, converts tokens to embeddings or features, and passes them to an emotion classification model. The emotion classifier outputs emotion labels and corresponding confidence scores. Server compares scores with stored thresholds to determine the emotional state classification (for example, “stress high,” “joy moderate”).
Output: an estimated emotional state and related score values.

### Step 8:

Server determines whether the emotional state is abnormal.
Server evaluates the emotion scores against predefined abnormality criteria.
Input: emotional state labels and numeric scores from the emotion estimation process.
Server executes conditional logic: if one or more scores exceed corresponding abnormal thresholds, Server flags the state as abnormal; otherwise, Server classifies the state as normal. Server logs this determination with a timestamp and user ID for monitoring and future learning.
Output: an abnormality flag (normal or abnormal) associated with the emotional state.

### Step 9:

Server dynamically constructs an augmented prompt sentence for the generative AI model.
Server retrieves the base persona prompt sentence and agent setting for the user, and combines them with emotion information.
Input: base persona prompt sentence, user profile, and current emotional state with abnormality flag.

Server generates an emotion-control clause, for example:
“The user currently appears to be under high stress. Respond in a calm and reassuring tone, avoid overwhelming detail, and provide brief, supportive suggestions.”

Server appends this clause to the base persona prompt sentence or merges it into a single control string. Server thus constructs an augmented prompt sentence that captures both long-term persona and short-term emotional context.
Output: an augmented prompt sentence ready for use in model invocation.

### Step 10:

Server generates response information using the generative AI model.

Server invokes the generative AI model with the augmented prompt sentence and the user's inquiry information.
Input: augmented prompt sentence and inquiry text.
Server structures model input as a sequence of messages or tokens and passes it to the generative AI model. The model processes the inputs through multiple layers, computing attention scores and generating token probabilities step by step until a stopping condition is met. Server receives the resulting text output and parses it into response information. When decision support is required, Server instructs the model via the augmented prompt sentence to output multiple options and associated scores or explanations, then parses these segments into separate option items and evaluation information.
Output: structured response information including one or more options and evaluation data.

### Step 11:

Server updates evaluation criteria and past behavior records.
Server compares the generated options and evaluation information with the user's subsequent selection (if provided).
Input: generated options and evaluation scores from the response, plus the user's chosen option when it becomes available.
Server writes the actual selection and context into the past behavior database. Server then analyzes aggregated data from multiple interactions to adjust evaluation weights or rules, for example by increasing the importance of features that frequently appear in chosen options. Server updates parameters stored in the agent setting and may regenerate future base prompt sentences to instruct the generative AI model to favor features that correlate with the user's real choices.
Output: updated evaluation criteria and updated user profile or agent setting parameters.

### Step 12:

Server generates warning or notification information when an abnormal emotional state is detected.
Server checks the abnormality flag generated during emotion estimation.
Input: emotional state classification and abnormality flag.

When the state is abnormal, Server prepares supportive warning text for the user, such as:
“You seem very stressed at the moment. Let us slow down. Would you like to take a short break or hear some simple relaxation tips?”
Server also constructs structured notification information including the emotional state, timestamp, and user identifier, and sends this to a management terminal operated by a caregiver or security staff when configured.
Output: warning information to the terminal and, optionally, notification information to a management terminal.

### Step 13:

Terminal presents response information and warnings to the user.
Terminal receives response information and any warning messages from the server.
Input: structured response data, including main reply text, options with evaluations, and warning text if present.
Terminal renders the main response in a conversation interface, lists options in a selectable format, and highlights warning messages in a distinguishable style. Terminal may optionally convert the text to speech using a text-to-speech engine and play the audio through the loudspeaker. User can read or listen to the response and select an option or issue a follow-up inquiry.
Output: displayed or spoken content delivered to the user and, when applicable, user selections returned to the server.

### Step 14:

User continues interaction and refines the persona through repeated use.
User repeatedly asks questions, selects options, and responds to suggestions.
Input: ongoing user queries and selection inputs at the terminal.
Over time, these interactions provide additional past behavior information. Terminal transmits this new information to the server, where it is incorporated into the user profile and used to further refine evaluation criteria and regenerate prompt sentences. This repeated cycle gradually makes the dialogue processing model more aligned with the user's real preferences and emotional patterns.
Output: richer historical data enabling progressively refined personalization and improved model behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

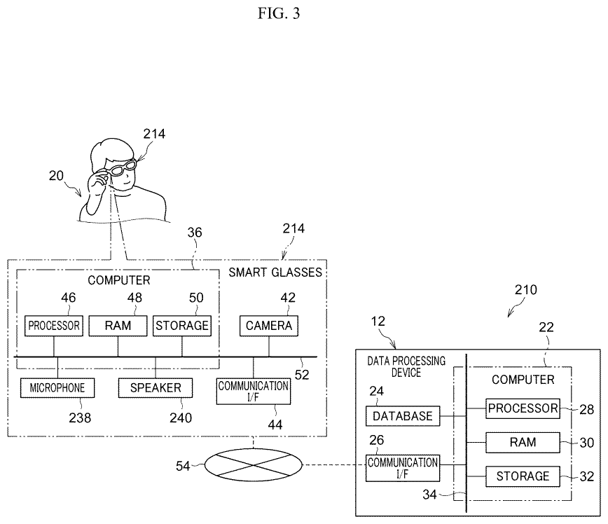

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

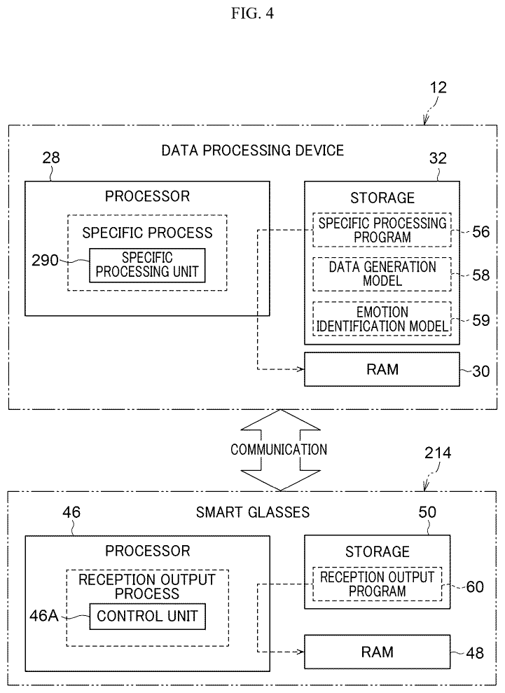

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

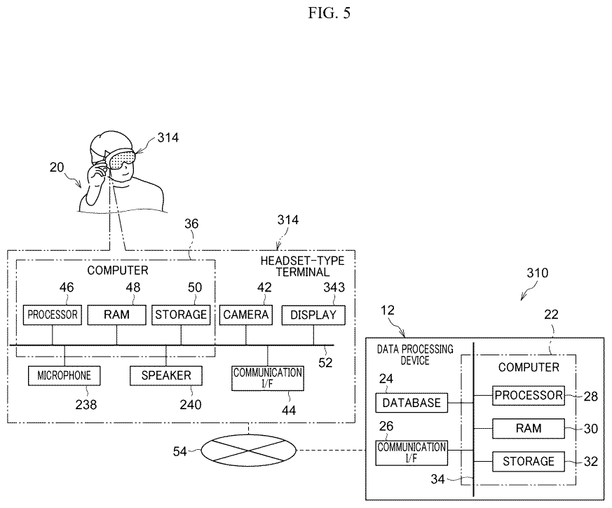

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

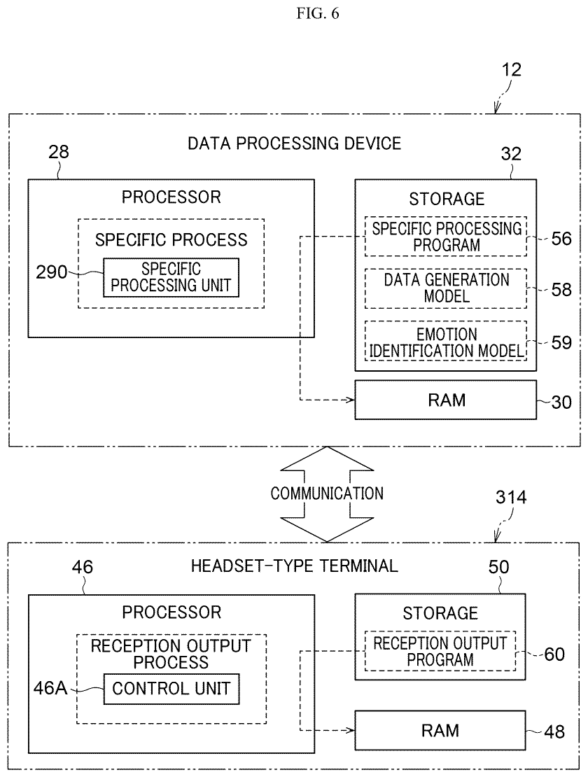

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

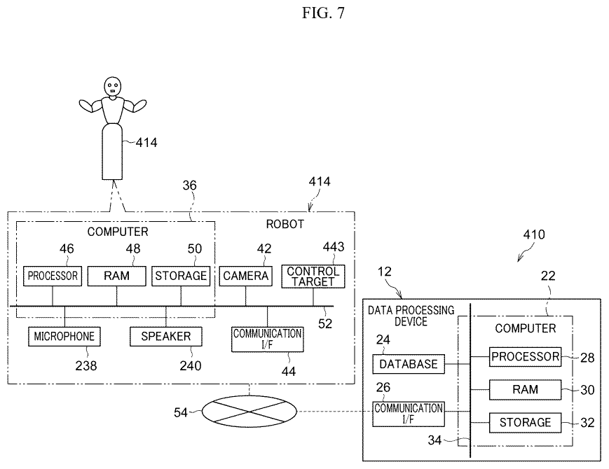

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

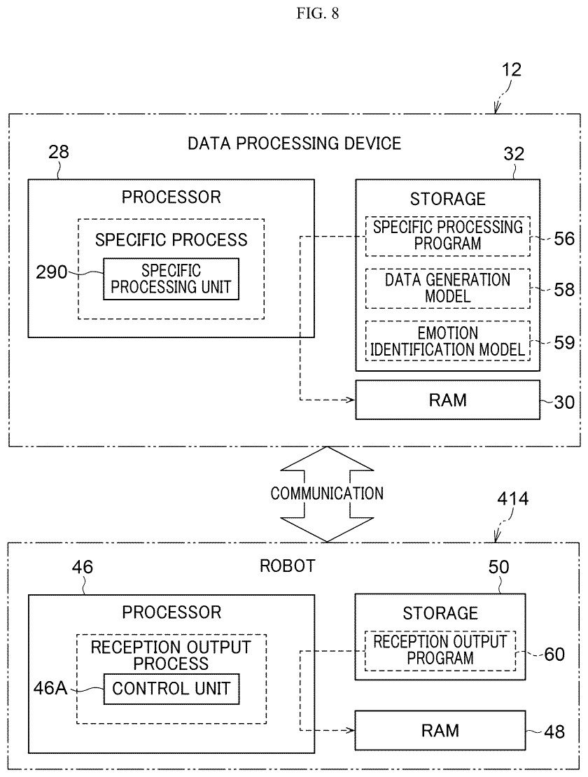

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

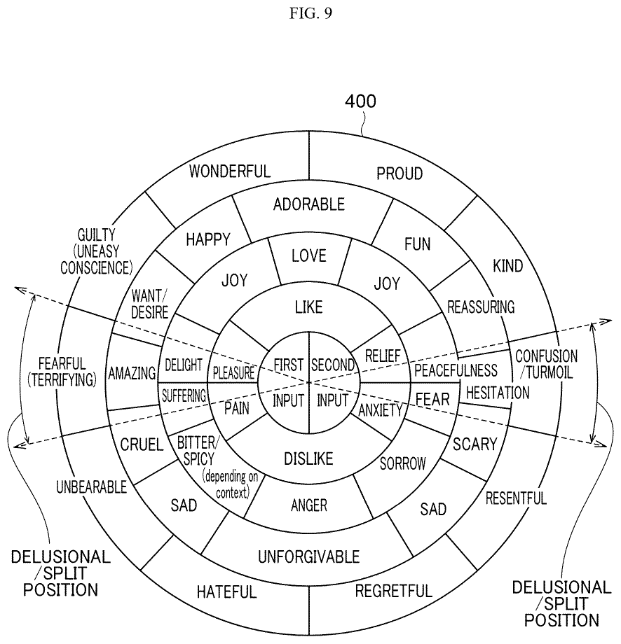

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

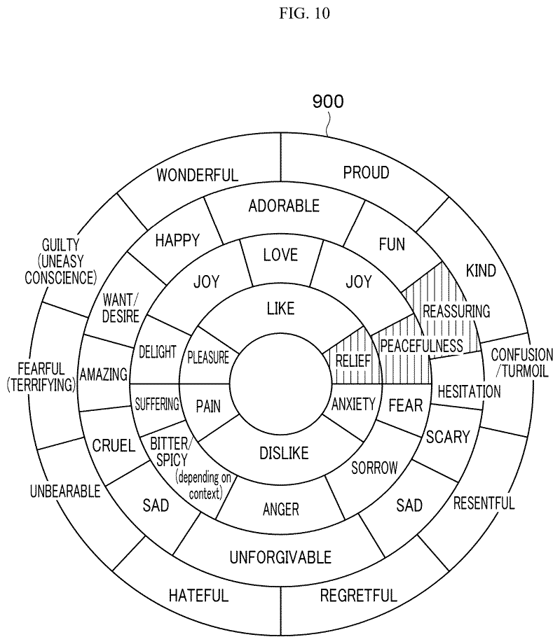

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire user information including at least an age, a biological sex, an area of interest, and a knowledge level of a user via an input device, convert the acquired user information into structured data, and store the structured data in a storage device,
generate, with reference to the structured data, a prompt sentence for causing a generative AI model to generate personality setting information that defines at least a dialogue characteristic, a recommendation policy, and a dialogue topic, input the prompt sentence into the generative AI model, obtain artificial intelligence setting data including the personality setting information from the generative AI model, and store the artificial intelligence setting data in the storage device,
generate, based on the artificial intelligence setting data, dialogue context data including a dialogue history with the user and a new prompt sentence received from the user, input the dialogue context data into the generative AI model, and cause the generative AI model to generate a response sentence adapted to attributes of the user,
generate, based on contents of the response sentence, a plurality of options and explanation information regarding each of the plurality of options for supporting a decision of the user, output the plurality of options via an output device, and store evaluation information regarding a selection input by the user for at least one of the plurality of options in the storage device, and update, based on the evaluation information and the dialogue history, at least one of a subsequent prompt sentence and the artificial intelligence setting data, and execute, in a continuous manner, individualized decision support processing and dialogue processing for the user.

### (Supplementary 2)

The System According to Supplementary 1,
wherein the processor is configured to calculate, based on the evaluation information and the user information, at least one weighting parameter and at least one output control parameter in the dialogue context data to be input into the generative AI model, and dynamically change, according to a result of the calculation, an evaluation criterion and a presentation order of the plurality of options.

### (Supplementary 3)

The system according to supplementary 1,
wherein the processor is configured to analyze, in real time, utterance content of the user acquired via at least one of a voice input device and a character input device, generate dialogue context data including the artificial intelligence setting data and environment information acquired from an external information source, input the dialogue context data into the generative AI model to sequentially generate a response sentence according to at least one of a psychological state and a living situation of the user in a caregiving environment, and present the response sentence to function as a continuous dialogue partner for the user.

### Application Example 1

### (Supplementary 1)

A system comprising a processor and a storage device,
wherein the processor is configured to
acquire user attribute information for each user and store the acquired user attribute information as a user-specific information set in the storage device,
generate a prompt sentence that defines behavior of a dialogue agent imitating a personality of the user, on the basis of the user attribute information and dialogue history information stored in the storage device, and input the prompt sentence to a generative AI model to cause the generative AI model to generate a personality-imitating artificial intelligence,
transmit inquiry data including the prompt sentence and an input sentence from the user to the generative AI model so as to execute response generation processing by the personality-imitating artificial intelligence, and acquire a response sentence output from the generative AI model,
generate option information for supporting decision-making of the user on the basis of content of the acquired response sentence, output the option information as presentation data to a user terminal, and acquire a selection result from the user terminal and record the selection result as evaluation information of the option information in the storage device, manage, for a plurality of users, the user attribute information, the dialogue history information, and the evaluation information in association with each other in the storage device, and individually adjust, for each user, configuration elements of the prompt sentence and content of the option information to be presented, and
communicate with the user terminal, receive the user attribute information and the input sentence from the user terminal, and transmit the response sentence and the option information to the user terminal.

### (Supplementary 2)

The system according to supplementary 1,
wherein the processor is configured to
include, in the prompt sentence to be input to the generative AI model, a description indicating at least the user attribute information, preference information, and physical and mental state information of the user so as to control the personality-imitating artificial intelligence to behave as a dialogue agent having values and an expression style similar to those of the user, and to update, over time, evaluation criteria and presentation methods of the option information for supporting selection by the user, on the basis of the dialogue history information and the evaluation information stored in the storage device.

### (Supplementary 3)

The system according to supplementary 1,
wherein the processor is configured to
receive, in real time, utterance content or input sentences of the user transmitted from a plurality of user terminals installed in a care environment, sequentially add the utterance content or the input sentences to the prompt sentence to be input to the generative AI model, cause the personality-imitating artificial intelligence to generate, for each user, a continuous and context-dependent response sentence, and present the response sentence as a dialogue partner to the user via the corresponding user terminal.

### Example 2

### (Supplementary 1)

A system comprising a processor,
wherein the processor is configured to
control a terminal interface to acquire attribute information of a user from a terminal operated by the user,
control a storage to store the acquired attribute information as structured information and to normalize the attribute information into higher-level categories,
generate, on the basis of the normalized attribute information, a prompt sentence that defines characteristics and usage purposes of the user, and input the prompt sentence into a generative AI model so as to generate an artificial intelligence agent that imitates the characteristics of the user,
store, in a recording medium, agent configuration information including identification information associated with the artificial intelligence agent and the prompt sentence, and read out the agent configuration information in response to a dialogue request from the terminal, generate input information by combining a natural-language prompt sentence acquired from the terminal with the agent configuration information, and re-input the input information into the generative AI model so as to cause the generative AI model to generate a response sentence adapted to the attribute information of the user,
control the terminal to present, on the basis of the response sentence, options for supporting decision-making of the user and evaluation information regarding the options, and perform post-processing on the response sentence and the evaluation information in accordance with safety criteria and appropriateness criteria, and transmit a result of the post-processing to the terminal.

### (Supplementary 2)

The system according to supplementary 1,
wherein the processor is configured to
dynamically adjust evaluation criteria and presentation formats used by the artificial intelligence agent for the options, on the basis of dialogue history acquired from the terminal and the attribute information of the user.

### (Supplementary 3)

The system according to supplementary 1,
wherein the processor is configured to
add, to the agent configuration information, a dialogue policy for a caregiving environment on the basis of attribute information of a user in the caregiving environment and utterance content acquired in real time from the terminal, and provide input information including the dialogue policy and the utterance content to the generative AI model so as to cause the generative AI model to generate an empathetic response sentence corresponding to an emotional state of the user, and output the empathetic response sentence to the terminal.

### Application Example 2

### (Supplementary 1)

A system comprising a processor,
wherein the processor is configured to
acquire user information including attribute information and past behavior information of a user,
generate a user profile comprising the attribute information and the past behavior information, and perform abstraction and normalization of the user profile, generate a prompt sentence on the basis of the user profile, the prompt sentence being configured to set, in a generative AI model, an information processing target that imitates a personality of the user,
input the prompt sentence into the generative AI model to construct a dialogue processing information processing model that imitates the personality of the user, and store the dialogue processing information processing model in a storage unit in association with an agent setting for the user,
execute a decision support process by using the dialogue processing information processing model to generate response information to inquiry information acquired from the user, the response information including presentation of a plurality of options and generation of evaluation information for the plurality of options on the basis of the user profile,
analyze natural language data included in the inquiry information and estimate an emotional state of the user by performing an emotion estimation process,
dynamically change a prompt sentence to be given to the dialogue processing information processing model in accordance with the emotional state and the user profile, and adjust content and an expression format of the response information generated by the dialogue processing information processing model, and
when the emotional state is determined to be an abnormal state exceeding a predetermined criterion, generate warning information for the user or notification information for a management terminal.

### (Supplementary 2)

The system according to supplementary 1,
wherein the processor is configured to update, over time, evaluation criteria for the plurality of options in the decision support process on the basis of the emotional state estimated by the emotion estimation process and a past selection history of the user, and to regenerate the prompt sentence included in the agent setting of the dialogue processing information processing model so as to continuously adjust the information processing model that imitates the personality of the user.

### (Supplementary 3)

The system according to Supplementary 1,
wherein the processor is configured to perform a speech recognition process that converts voice information acquired as the inquiry information into character information, and to perform a speech synthesis process that outputs the response information as voice information, and
wherein the dialogue processing information processing model is configured to generate, in real time, dialogue responses and warning responses corresponding to the emotional state in a care environment or a security environment.

What is claimed is:

1. A system comprising:
a communication interface coupled to a packet-switched network; and
circuitry configured to:
acquire user attribute data from a terminal device via the communication interface, convert the user attribute data into structured data, and store the structured data in a storage device;
generate, based on the structured data, a prompt for causing a generative neural network model to generate personality setting information defining at least a dialogue characteristic, a recommendation policy, and a dialogue topic, input the prompt to the generative neural network model, and store the personality setting information in the storage device;
generate, based on the personality setting information, dialogue context data comprising a dialogue history and a new input received from the terminal device, input the dialogue context data to the generative neural network model, and cause the generative neural network model to generate a response adapted to the user attribute data;
generate, based on the response, a plurality of options and explanation information for each option, transmit the options and explanation information to the terminal device via the packet-switched network, and store evaluation information regarding a selection input received from the terminal device; and
update, based on the evaluation information and the dialogue history, at least one of a subsequent prompt and the personality setting information to refine subsequent response generation.

2. The system according to claim 1, wherein the user attribute data comprises at least an age parameter, a biological sex parameter, an area of interest parameter, and a knowledge level parameter, and wherein the circuitry maps each parameter to a corresponding field in the structured data.

3. The system according to claim 2, wherein the prompt for generating the personality setting information comprises a structured template format including the mapped parameter fields and instruction segments specifying output format constraints for the personality setting information.

4. The system according to claim 3, wherein the personality setting information further comprises tone adjustment parameters, vocabulary complexity level, and topic prioritization weights, and wherein the circuitry stores the personality setting information as a configuration record associated with a session identifier.

5. The system according to claim 4, wherein the circuitry is further configured to generate the dialogue context data by concatenating a system instruction segment derived from the personality setting information, the dialogue history comprising a sequence of prior input-response pairs, and the new input from the terminal device.

6. The system according to claim 5, wherein the circuitry is further configured to apply a context window management process that selects a subset of the dialogue history based on recency and relevance scoring when a total token count of the dialogue context data exceeds a maximum input length of the generative neural network model.

7. The system according to claim 1, wherein the circuitry is further configured to generate the plurality of options by constructing an option-generation prompt that includes the response, the personality setting information, and a specification of a number of options to generate, and inputting the option-generation prompt to the generative neural network model.

8. The system according to claim 7, wherein the explanation information for each option comprises at least a rationale text, a compatibility score derived from the personality setting information, and a risk assessment indicator.

9. The system according to claim 8, wherein the circuitry is further configured to rank the plurality of options based on the compatibility score and to present the ranked options to the terminal device with the highest-ranked option indicated.

10. The system according to claim 9, wherein the circuitry is further configured to dynamically adjust evaluation criteria for ranking the options based on the evaluation information from prior selection inputs, the adjustment comprising updating weighting coefficients associated with the personality setting information.

11. The system according to claim 1, wherein the circuitry is further configured to perform emotion estimation processing on input data received from the terminal device comprising at least one of text data, audio data, and image data, to generate emotion state data, and to incorporate the emotion state data into the dialogue context data.

12. The system according to claim 11, wherein the emotion estimation processing comprises applying a neural network classifier trained on labeled emotional-state examples to the input data to produce an emotion label and an intensity score.

13. The system according to claim 12, wherein the circuitry is further configured to adjust the tone adjustment parameters of the personality setting information based on the emotion state data, and to incorporate the adjusted parameters into the prompt for generating the response.

14. The system according to claim 1, wherein the circuitry is further configured to analyze the dialogue history to extract behavioral patterns comprising topic frequency, selection tendency, and engagement duration, and to generate a behavioral profile stored in the storage device.

15. The system according to claim 14, wherein the circuitry is further configured to append the behavioral profile to the prompt for generating the personality setting information during periodic re-generation of the personality setting information, thereby adapting the personality setting information to observed behavioral patterns.

16. The system according to claim 1, wherein the dialogue context data further comprises utterance content from a user in a care environment, and wherein the response comprises conversational content generated by the generative neural network model adapted to function as a personalized conversation partner.

17. The system according to claim 16, wherein the circuitry is further configured to calculate a closed-loop induction rate based on a ratio of accepted options to total presented options over a plurality of dialogue sessions, and to adjust generation parameters of the generative neural network model when the induction rate falls below a threshold.

18. A system comprising:
a communication interface coupled to a packet-switched network; and
circuitry configured to:
acquire user attribute data comprising age, biological sex, area of interest, and knowledge level from a terminal device via the communication interface, convert the data into structured fields, and store the structured fields in a storage device with a session identifier;
generate a personality-setting prompt comprising a structured template format with the structured fields and instruction segments, input the prompt to a generative neural network model, obtain personality setting information comprising dialogue characteristic, recommendation policy, dialogue topic, tone adjustment parameters, and vocabulary complexity level, and store the personality setting information;
generate dialogue context data by concatenating a system instruction derived from the personality setting information, a dialogue history, and new input from the terminal device, applying context window management when a token count exceeds a maximum input length, and input the dialogue context data to the generative neural network model to generate a response;
construct an option-generation prompt including the response and the personality setting information, input the prompt to the generative neural network model to generate a plurality of options each with rationale text and a compatibility score, rank the options, and transmit the ranked options to the terminal device;
store evaluation information from the terminal device and update weighting coefficients for option ranking based on the evaluation information; and
perform emotion estimation processing on input data from the terminal device to generate emotion state data, adjust the tone adjustment parameters based on the emotion state data, and incorporate the adjusted parameters into subsequent prompts.

19. The system according to claim 18, wherein the circuitry is further configured to analyze the dialogue history to extract behavioral patterns comprising topic frequency, selection tendency, and engagement duration, and to periodically re-generate the personality setting information incorporating the behavioral patterns.

20. A method comprising:
acquiring, by circuitry coupled to a packet-switched network, user attribute data from a terminal device and storing the user attribute data as structured data in a storage device;
generating, based on the structured data, a prompt for a generative neural network model to generate personality setting information defining a dialogue characteristic, a recommendation policy, and a dialogue topic, and inputting the prompt to the generative neural network model to obtain the personality setting information;
generating dialogue context data comprising a dialogue history and new input, inputting the dialogue context data to the generative neural network model, and generating a response adapted to the user attribute data;
generating a plurality of options and explanation information based on the response, transmitting the options to the terminal device, and storing evaluation information regarding a selection input; and
updating, based on the evaluation information and the dialogue history, at least one of a subsequent prompt and the personality setting information to refine subsequent response generation.
